(19) United States
(12) Patent Application Publication
(10) Pub. No.: US 2026/0134656 A1
(43) Pub. Date: May 14, 2026

(54) INFORMATION PROCESSING DEVICE, INFORMATION PROCESSING METHOD, COMPUTER PROGRAM PRODUCT, AND SERVER

(71) Applicant: KABUSHIKI KAISHA TOSHIBA, Kawasaki-shi Kanagawa (JP)

(72) Inventors: Yutaka Yamada, Fuchu Tokyo (JP); Kosuke Tatsumura, Yokohama Kanagawa (JP); Yohei Hamakawa, Kawasaki Kanagawa (JP); Yutaro Ishigaki, Kawasaki Kanagawa (JP)

(73) Assignee: KABUSHIKI KAISHA TOSHIBA, Kawasaki-shi Kanagawa (JP)

(21) Appl. No.: 19/311,121

(22) Filed: Aug. 27, 2025

(30) Foreign Application Priority Data
Nov. 14, 2024 (JP) 2024-198693
May 14, 2025 (JP) 2025-081016

(51) Int. Cl. G06V 10/44; G06T 7/11; G06T 7/246; G06T 7/70; G06V 10/75; G06V 10/771

(52) U.S. Cl. CPC G06V 10/44; G06T 7/11; G06T 7/246; G06T 7/70; G06V 10/751; G06V 10/771

(57) ABSTRACT

According to an embodiment, an information processing device includes one or more hardware processors configured to: generate, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and generate, based on a solution to the matching problem, a corresponding point list representing a corresponding point pair including any first feature point of the N first feature points and an associated second feature point among the M second feature points.

### CROSS-REFERENCE TO RELATED APPLICATIONS

This application is based upon and claims the benefit of priority from Japanese Patent Application No. 2024-198693, filed on Nov. 14, 2024 and Japanese Patent Application No. 2025-081016, filed on May 14, 2025; the entire contents of which are incorporated herein by reference.

### FIELD

Embodiments of the present invention relate to an information processing device, an information processing method, a computer program product, and a server.

### BACKGROUND

An autonomous movement system that autonomously moves a moving body such as an automatic driving vehicle and an automated guided vehicle is known. The autonomous movement system estimates the position of the moving body in the surrounding environment in order to appropriately move the moving body. As a technique for estimating a position of a moving body, simultaneous localization and mapping (SLAM) is known.

As one of the SLAMs, a technology called visual SLAM that estimates a self-position, which is a position of a camera, using an image captured by the camera is known. The visual SLAM is a technique of tracking a feature point detected from a captured image and estimating a self-position based on a change in the position of the feature point in a plurality of consecutive captured images. In a case where the self-position is estimated by the visual SLAM, feature point matching is required between two captured images. Therefore, in a case where the self-position is estimated by the visual SLAM, a technique for accurately matching feature points between two captured images is required.

A technique called ORB SLAM is known as one of the visual SLAMs. The ORB SLAM selects a set of two feature points having high similarity of local feature amounts as a set of corresponding points. However, in the ORB SLAM, in a case where a plurality of objects having similar shapes such as trees, lightings, windows, and the like are included in a captured image, even two feature points at spatially different positions may be determined as a set of two feature points in a case where similarity is high, and erroneous matching may be performed.

In addition, a technique of selecting a set of corresponding points using a feature amount in which coordinate information is incorporated into a local feature amount by using a neural network is also known. However, such a technique requires large-scale computation by a large-scale neural network, and in a case where the technique is applied to an automatic driving vehicle and an autonomous traveling robot, which are battery-driven, power consumption increases, which has a problem.

In addition, there is also known a technique for avoiding erroneous matching in which two feature points separated with a distance are erroneously set as a set of corresponding points by limiting a search range of a set of corresponding points to a predetermined range. However, in such a technique, since the search range is uniformly defined on the image, it is difficult to give appropriate constraints to each of a set of two feature points largely separated from each other and a set of two feature points located relatively close to each other, and there has been a possibility of erroneous matching.

### BRIEF DESCRIPTION OF THE DRAWINGS

FIG. 1 is a diagram illustrating a configuration of a moving body control system according to the embodiment;

FIG. 2 is a diagram illustrating a functional configuration of a self-position estimation device;

FIG. 3 is a diagram illustrating an example of a configuration of an estimation unit;

FIG. 4 is a view illustrating an example of a first image, a second image, and an imaging position of a camera;

FIG. 5 is a flowchart illustrating a flow of processing of the self-position estimation device according to the embodiment;

FIG. 6 is a diagram illustrating a functional configuration of a matching unit;

FIG. 7 is a diagram illustrating a functional configuration of a problem generation unit;

FIG. 8 is a diagram illustrating a functional configuration of a matching unit according to the first modification;

FIG. 9 is a diagram illustrating a functional configuration of a self-position estimation device according to the second modification;

FIG. 10 is a diagram illustrating a functional configuration of a self-position estimation device according to the third modification;

FIG. 11 is a view illustrating a plurality of partial images obtained by dividing an input image;

FIG. 12 is a flowchart illustrating a flow of processing of the self-position estimation device according to the third modification;

FIG. 13 is a view illustrating a plurality of partial images that partially overlaps;

FIG. 14 is a diagram illustrating a functional configuration of a matching unit according to the fourth modification;

FIG. 15 is a diagram for describing the content of selection processing and decoding processing of the candidate point;

FIG. 16 is a diagram illustrating a model of an Ising problem;

FIG. 17 is a diagram illustrating internal variables used by a simulated bifurcation algorithm;

FIG. 18 is a flowchart illustrating a flow of a process of a simulated bifurcation machine; and

FIG. 19 is a diagram illustrating an example of a hardware configuration of a computer.

### DETAILED DESCRIPTION

According to an embodiment, an information processing device includes one or more hardware processors configured to: generate, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and generate, based on a solution to the matching problem, a corresponding point list representing a corresponding point pair including any first feature point of the N first feature points and an associated second feature point among the M second feature points.

Hereinafter, embodiments of the present invention will be described with reference to the accompanying drawings.

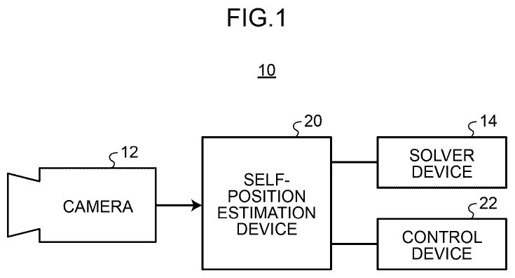

FIG. 1 is a diagram illustrating a configuration of a moving body control system 10 according to the embodiment. The moving body control system 10 controls a moving operation of a moving body such as an automatic driving vehicle, an automated guided vehicle, a drone, and an autonomous traveling robot, for example.

The moving body control system 10 includes a camera 12, a solver device 14, a self-position estimation device 20, and a control device 22.

The camera 12 is mounted on a moving body. The camera 12 captures an image of the surrounding environment of the moving body. The camera 12 captures an image of the surrounding environment at predetermined time intervals to generate an input image. The camera 12 outputs the generated input image at predetermined time intervals.

The camera 12 may be a monocular camera or a stereo camera. The camera 12 may be a color camera, a monochrome camera, or a near-infrared (NIR) camera. The camera 12 may be an RGB-D camera or LiDAR that can measure the distance to the subject.

The solver device 14 acquires a combination optimization problem that maximizes or minimizes an objective function to output a solution to the acquired combination optimization problem. The objective function is a function including a plurality of decision variables. The solver device 14 outputs data representing each value of the plurality of decision variables as a solution.

The solver device 14 acquires a matching problem that is a combination optimization problem from the self-position estimation device 20. The solver device 14 provides a solution to the acquired matching problem to the self-position estimation device 20. Note that, in a case where the self-position estimation device 20 solves the matching problem by itself, the moving body control system 10 may not include the solver device 14.

The solver device 14 is provided on the moving body on which the camera 12 is mounted, for example, together with the self-position estimation device 20. Furthermore, the solver device 14 may be connected to the self-position estimation device 20 via a network and provided at a location different from that of the moving body. For example, the solver device 14 may be implemented in a server device on a network. Furthermore, for example, the solver device 14 may be included inside the self-position estimation device 20.

The solver device 14 is, for example, an Ising machine. The Ising machine may be, for example, a simulated bifurcation machine. Details of the Ising machine and the simulated bifurcation machine will be described later.

The self-position estimation device 20 is an information processing device including a reception circuit, a processor, a read only memory (ROM), a random access memory (RAN), an accelerator, and the like.

The reception circuit acquires an input image captured by the camera 12 at predetermined time intervals. The processor is, for example, a central processing unit (CPU). The processor may be a multiprocessor. Furthermore, the processor may be a digital signal processor (DSP), a graphic processing unit (GPU), a circuit obtained by combining these, or the like. In addition, the processor may include an image signal processor (ISP).

The ROM stores programs executed by the processor and parameters used by the processor. The RAM stores an input image received from the camera 12, data executed by the processor and the accelerator, and the like. The accelerator executes a predetermined arithmetic process such as an image process and a signal process instead of the processor. The accelerator is realized by, for example, a dedicated circuit, an arithmetic circuit such as a CPU, a DSP, a GPU, or a neural processing unit (NPU), or these circuits.

The self-position estimation device 20 having such a configuration acquires an input image from the camera 12 at predetermined time intervals. The self-position estimation device 20 estimates a self-position that is a position of the camera 12 in a three-dimensional space based on an input image at predetermined time intervals. The self-position estimation device 20 may estimate the posture of the camera 12 in the three-dimensional space as the self-position. Since the camera 12 is mounted on the moving body, the self-position estimation device 20 can estimate the position and the posture of the camera 12 as the position and the posture of the moving body.

Furthermore, the self-position estimation device 20 generates a matching problem that is a combination optimization problem during the processing of estimating the self-position. The self-position estimation device 20 provides the generated matching problem to the solver device 14 to acquire a solution to the matching problem from the solver device 14. Then, the self-position estimation device 20 executes self-position estimation processing based on the acquired solution to the matching problem. Note that, in a case where the matching problem can be easily solved, the self-position estimation device 20 may solve the matching problem by itself without providing the matching problem to the solver device 14.

For example, the self-position estimation device 20 estimates the self-position at regular time intervals, and provides the self-position estimated at regular time intervals to the control device 22.

The control device 22 acquires the self-position estimated by the self-position estimation device 20, for example, at regular time intervals, and controls a drive mechanism or the like of the moving body based on the acquired self-position.

Such a moving body control system 10 can appropriately move the moving body from the departure position to the destination position, for example.

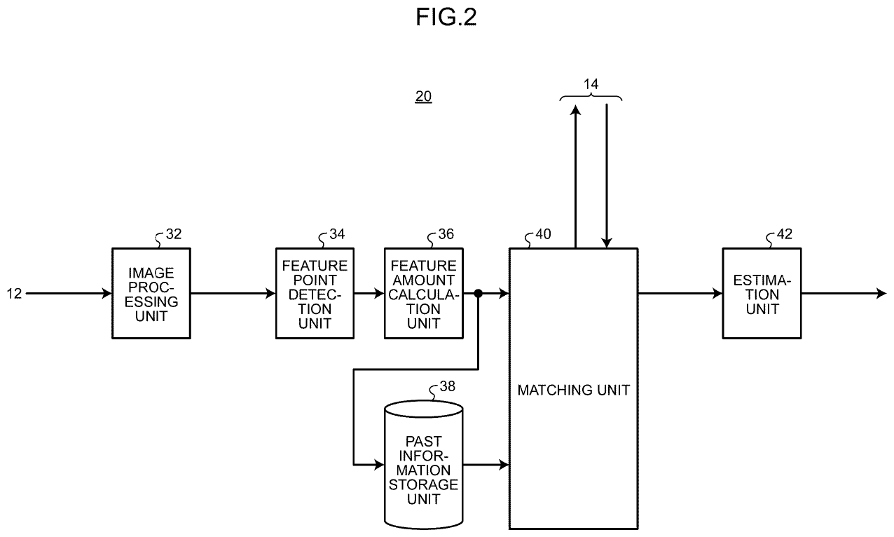

FIG. 2 is a diagram illustrating a functional configuration of the self-position estimation device 20.

The self-position estimation device 20 includes an image processing unit 32, a feature point detection unit 34, a feature amount calculation unit 36, a past information storage unit 38, a matching unit 40, and an estimation unit 42. The image processing unit 32, the feature point detection unit 34, the feature amount calculation unit 36, the matching unit 40, and the estimation unit 42 are included in a processing unit of the information processing device.

The image processing unit 32 acquires an input image from the camera 12 at predetermined time intervals. The image processing unit 32 performs an image process on each of the input images acquired at predetermined time intervals. For example, in a case where the camera 12 outputs an input image that is a RAW image, the image processing unit 32 may convert the RAW image into an RGB image or a monochrome image. Furthermore, the image processing unit 32 may execute processing such as demosaic, noise removal, image quality adjustment, distortion correction processing, and shape conversion processing on the acquired input image.

Furthermore, in a case where the self-position estimation device 20 includes an ISP as hardware, the image processing unit 32 may execute image conversion processing using the ISP. For example, the image processing unit 32 may temporarily store the acquired data of the input image in the RAM and execute various types of processes on the input image stored in the RAM.

The feature point detection unit 34 acquires the input image subjected to the image processing by the image processing unit 32 at predetermined time intervals. The feature point detection unit 34 detects one or a plurality of feature points from each of the input images every predetermined time. The feature point detection unit 34 may detect the same or different number of feature points for each of the input images at predetermined time intervals.

Each of the one or a plurality of feature points is a point representing a characteristic object in the input image. The feature point detection unit 34 detects a feature point from the input image by a predetermined algorithm. The feature point detection unit 34 may detect a feature point by any algorithm. For example, the feature point detection unit 34 may detect a feature point by an algorithm of features from accelerated segment test (FAST). Furthermore, the feature point detection unit 34 may detect a feature point using an algorithm such as Harris's corner detector. Furthermore, the feature point detection unit 34 may detect a feature point using a neural network. In addition, in a case where the accelerator has a function of executing a feature point detection algorithm, the feature point detection unit 34 gives an input image to the accelerator to detect a feature point.

The feature point detection unit 34 generates a feature point list representing coordinates of one or a plurality of feature points on each image for each input image at predetermined time intervals. In addition, the feature point list may include, for each of one or a plurality of feature points, a feature point score that is a certain parameter calculated in the feature point detection processing. Furthermore, in a case where a feature point is detected by an algorithm using a hierarchical structure such as the FAST, the feature point list may further include an identifier for identifying a hierarchy for each of one or a plurality of feature points.

Then, the feature point detection unit 34 provides a set of the input image and the feature point list to the feature amount calculation unit 36 for each input image at predetermined time intervals.

The feature amount calculation unit 36 acquires a set of an input image and a feature point list for each input image at predetermined time intervals. The feature amount calculation unit 36 calculates a feature amount from the input image by a predetermined algorithm for each of one or a plurality of feature points included in the feature point list for each input image at predetermined time intervals. The feature amount calculation unit 36 may calculate the feature amount by any algorithm.

For example, the feature amount calculation unit 36 calculates the feature amount by an algorithm such as scale-invariant feature transform (SIFT), speed-upped robust feature (SURF), binary robust independent elementary features (BRIEF), or accelerated KAZE (AKAZE). Furthermore, for example, the feature amount calculation unit 36 may calculate the feature amount using a neural network such as ResNet or Vision_Trans_former. Furthermore, the feature amount calculation unit 36 may include a feature related to a position in the image, a positional relationship with another feature point, or the like in addition to the feature related to the shape of the image.

In addition, the feature amount calculation unit 36 may execute the feature amount calculation processing simultaneously with the feature point detection processing instead of executing the feature amount calculation processing after the feature point detection processing. For example, the feature point detection unit 34 and the feature amount calculation unit 36 may simultaneously perform the feature point detection processing and the feature amount calculation processing by an oriented-BRIEF (ORB) algorithm. Furthermore, for example, the feature point detection unit 34 and the feature amount calculation unit 36 may simultaneously perform the feature point detection processing and the feature amount calculation processing by the algorithm of Super_Point described in “Daniel DeTone, Tomasz Malisiewicz, Andrew Rabinovich, “SuperPoint:Self-Supervised Interest Point Detection and Description” arXiv:1712.07629v4, <URL,https://doi.org/10.48550/arXiv.1712.07629>, April 2016”.

The feature amount calculation unit 36 generates a feature amount list including a feature amount for each of one or a plurality of feature points for each input image at predetermined time intervals. Then, the feature amount calculation unit 36 provides the feature point list and the feature amount list to the past information storage unit 38, the matching unit 40, and the estimation unit 42 for each input image at predetermined time intervals.

The past information storage unit 38 stores a feature point list and a feature amount list of past input images. The matching unit 40 refers to the feature point list and the feature amount list of the past input image stored in the past information storage unit 38.

For example, the past information storage unit 38 stores a feature point list and a feature amount list for the input image immediately before the input image to be processed by the matching unit 40. Furthermore, for example, the past information storage unit 38 may store a feature point list and a feature amount list for a key frame image before the input image to be currently processed by the matching unit 40. The key frame image is, for example, an input image selected at intervals longer than predetermined time intervals at which the input image is captured. The key frame image may be an input image that satisfies a predetermined condition. Furthermore, the key frame image may be an input image indicated in map information stored in the estimation unit 42 described later. The past information storage unit 38 may delete the feature point list and the feature amount list of the past input image that is no longer referred to in the matching unit 40 as time elapses.

The matching unit 40 acquires a feature point list and a feature amount list for each input image at predetermined time intervals.

Here, an input image to be currently processed by the matching unit 40 among input images at predetermined time intervals is defined as a first image. Further, among the input images at predetermined time intervals, an input image before the first image is set as the second image, which is different from the first image to be currently processed by the matching unit 40. For example, the second image is an input image immediately before the first image. Furthermore, for example, the second image may be a key frame image before the first image.

The matching unit 40 acquires the feature point list and the feature amount list detected and calculated from the first image from the feature amount calculation unit 36. Further, the matching unit 40 acquires the feature point list and the feature amount list detected and calculated from the second image from the past information storage unit 38.

In addition, it is assumed that N first feature points (N is an integer greater than or equal to one) are detected as one or a plurality of feature points from the first image. In addition, it is assumed that M second feature points (M is an integer greater than or equal to one) are detected as one or a plurality of feature points from the second image.

The matching unit 40 generates a matching problem based on the N first feature points detected from the first image and the M second feature points (M is an integer greater than or equal to one) detected from the second image. The matching problem is a combination optimization problem in which any second feature point estimated to represent the same object among the M second feature points is associated with each of the N first feature points.

The matching unit 40 provides the generated matching problem to the solver device 14 to acquire a solution to the matching problem from the solver device 14. Note that, in a case where the matching problem can be easily solved, the matching unit 40 may solve the matching problem by itself without providing the matching problem to the solver device 14.

Based on the solution to the matching problem, the matching unit 40 associates any second feature point estimated to represent the same object among the M second feature points with each of the N first feature points. Note that the matching unit 40 associates zero or one second feature point of the M second feature points with each of the N first feature points, and associates zero or one first feature point of the N first feature points with each of the M second feature points. That is, the matching unit 40 does not associate two or more second feature points with each of the N first feature points, and does not associate two or more first feature points with each of the M second feature points. In addition, the matching unit 40 may include a first feature point that is not associated with any second feature point among the N first feature points, and may include a second feature point that is not associated with any first feature point among the M second feature points.

Then, the matching unit 40 generates a corresponding point list representing corresponding point pairs based on the solution to the matching problem. The corresponding point pair includes any first feature point of the N first feature points and a second feature point associated as the same object among the M second feature points. Note that the corresponding point list may represent a plurality of corresponding point pairs. Furthermore, the corresponding point list may not represent corresponding point pairs, that is, may represent zero corresponding point pairs.

The matching unit 40 provides the generated corresponding point list to the estimation unit 42 for each input image at predetermined time intervals. Further details of the matching unit 40 will be described later.

The estimation unit 42 acquires a feature point list, a feature amount list, and a corresponding point list for each input image at predetermined time intervals. Then, the estimation unit 42 estimates the self-position, which is the position of the camera 12 in the three-dimensional space, based on the acquired feature point list, feature amount list, and corresponding point list for predetermined time intervals. The estimation unit 42 may estimate the posture of the camera 12 in the three-dimensional space as the self-position. Then, the estimation unit 42 provides the estimated self-position to the control device 22.

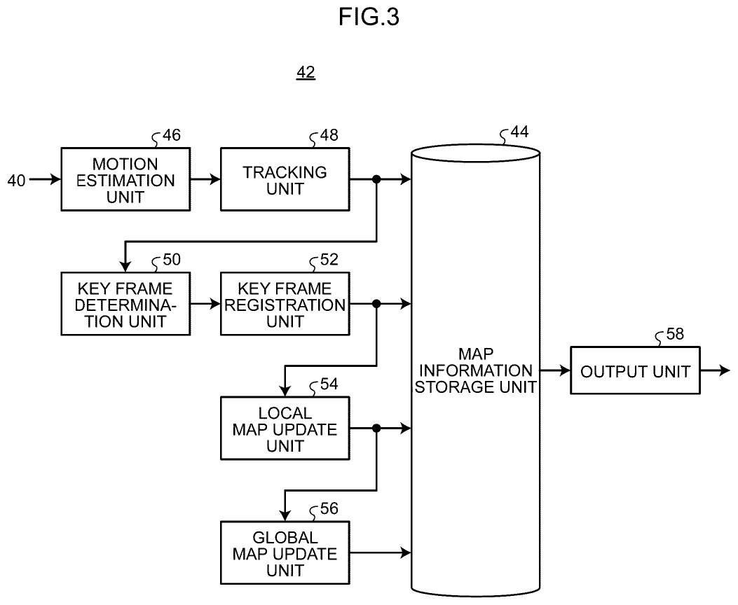

FIG. 3 is a diagram illustrating an example of a configuration of the estimation unit 42.

The estimation unit 42 includes a map information storage unit 44, a motion estimation unit 46, a tracking unit 48, a key frame determination unit 50, a key frame registration unit 52, a local map update unit 54, a global map update unit 56, and an output unit 58.

The map information storage unit 44 stores map information. The map information includes key frame information and map point information.

The key frame information includes, for each of one or a plurality of key frame images, a key frame identifier for identifying the key frame image, the self-position of the camera 12 at the time of capturing the key frame image in the world coordinate system, and a feature point list detected from the key frame image.

The map point information includes, for each of one or a plurality of map points, an identifier of the map point, a position in the world coordinate system, and identification information for identifying a feature amount of the map point. The map point represents an object detected as a feature point. Furthermore, the map point information may include information indicating a key frame including the map point.

Further, the key frame information may include, for each of the one or a plurality of key frame images, information indicating a relationship with another key frame image. For example, the key frame information may include, for each of one or a plurality of key frame images, information indicating a relative positional relationship between the self-position and the self-position of the camera 12 at the time of capturing another key frame image. Furthermore, the key frame information may include, for each of one or a plurality of key frame images, information indicating included map points and information indicating a relative positional relationship between the included map point and the self-position.

The motion estimation unit 46 acquires the corresponding point list for each input image at predetermined time intervals. The motion estimation unit 46 estimates the self-position of the camera 12 that has captured the target input image for each input image at predetermined time intervals. For example, the motion estimation unit 46 solves a perspective-n-point (PnP) problem from the corresponding point pair included in the corresponding point list, thereby estimating the relative amount of movement from the position of the camera 12 that has captured the past input image to the position of the camera 12 that has captured the input image to be processed. Then, for example, the motion estimation unit 46 estimates the self-position of the camera 12 that has captured the input image to be processed based on the self-position of the camera 12 that has captured the past input image that has already been estimated and the estimated relative amount of movement. Note that the motion estimation unit 46 may estimate the self-position by another method instead of such an estimation method.

The tracking unit 48 associates each of one or a plurality of map points represented by the map point information with any of one or a plurality of feature points included in the feature point list of the input image to be processed. Then, the tracking unit 48 optimizes each of one or a plurality of map points based on the self-position calculated by the motion estimation unit 46, the feature point list, and the feature amount list, and updates the map point information.

Note that the tracking unit 48 may update information about a map point on the local map among one or a plurality of map points. The local map represents a three-dimensional range near the self-position of the input key frame image, which is the most recent key frame image.

The key frame determination unit 50 determines whether the input image to be processed is a key frame image. For example, the key frame determination unit 50 determines that the input image is a key frame image for each predetermined number of input images. In addition, the key frame determination unit 50 may determine that the input image is a key frame image in a case where the input image satisfies a predetermined condition.

In a case where it is determined that the input image is a key frame image, the key frame registration unit 52 updates the key frame information stored in the map information storage unit 44 using the input image as a key frame image.

The local map update unit 54 updates the position of each of one or a plurality of map points on the local map and the self-position of the key frame image each time the key frame image is registered or each time a predetermined number of key frame images is registered.

The local map update unit 54 acquires the self-position of the camera 12 at the time of capturing the input key frame image, the relationship with the past key frame image temporally close to the input key frame image, the feature point list in the input key frame image, the key frame information of the past key frame image temporally close to the input key frame image, and the like. The input key frame image is a key frame image to be updated. Then, the local map update unit 54 calculates the positions of the key points by triangulation, performs bundle adjustment, and the like based on the acquired information, and optimizes the position of the map point on the local map and the self-position of the camera 12 at the time of capturing the input key frame image. Furthermore, the local map update unit 54 may delete redundant map points, delete redundant key frame images, and the like.

The global map update unit 56 updates the position of each of one or a plurality of map points and the self-position of the camera 12 at the time of imaging for each of one or a plurality of key frame images on the global map. The global map represents a three-dimensional range wider than the local map, for example, a three-dimensional range from the position where the moving body starts moving to the current position. For example, the global map update unit 56 performs bundle adjustment or the like to optimize the position of each of one or a plurality of map points on the global map and the self-position of the camera 12 at the time of imaging for each of a plurality of key frame images.

Note that the local map update unit 54 can execute the optimization processing with a relatively small processing amount. However, the local map update unit 54 accumulates errors of the self-position of the key frame image, and the accuracy of the optimization processing is relatively poor. On the other hand, the global map update unit 56 has high optimization accuracy but a large processing amount. Therefore, the global map update unit 56 executes the optimization processing at a frequency less than the frequency of execution of the optimization processing by the local map update unit 54. For example, the global map update unit 56 may perform the optimization processing every predetermined time, or may perform the optimization processing every time a certain number of key frame images are registered. Furthermore, the global map update unit 56 may perform the optimization processing in a case where the self-position of the camera 12 at the time of capturing the key frame image returns to the already-registered spatial region, that is, in a case where the movement route is looped.

The output unit 58 outputs the current self-position to the control device 22 every predetermined time. In addition, the output unit 58 may output identification information for identifying the position and the feature amount of each of one or a plurality of map points to the control device 22.

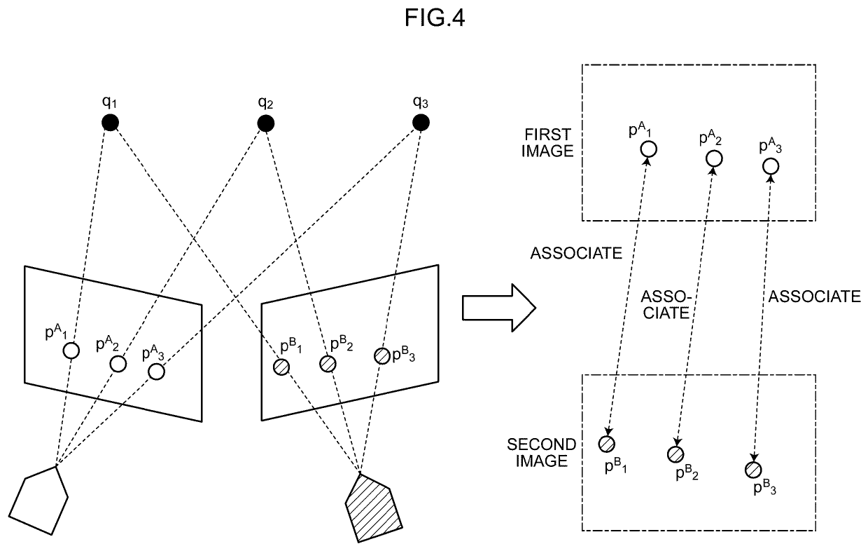

FIG. 4 is a diagram illustrating an example of the first image, the second image, and imaging positions of the camera 12.

In FIG. 4, the first image is an image obtained by imaging q₁, q₂, and q₃, which are stationary objects, by the camera 12 at the first time (t1). In FIG. 4, the second image is an image obtained by imaging q₁, q₂, and q₃ by the camera 12 at the second time (t2) before the first time (t1). An imaging position of the camera 12 at the first time (t1) is different from that at the second time (t2).

Each of p^{A}₁, p^{A}₂, and p^{A}₃ is a feature point included in the first image. Each of p^{B}₁, p^{B}₂, and p^{B}₃ is a feature point included in the second image. p^{A}₁ and p^{B}₂ represent q₁ on the image. p^{A}₂ and p^{B}₂ represent q₂ on the image. p^{A}₃ and p^{B}₃ represent q₃ on the image.

In the present embodiment, the self-position estimation device 20 detects N first feature points as one or a plurality of feature points from the first image. Then, the self-position estimation device 20 generates a feature point list (P^{A}) represented by Expression (1).

$${P}_{A} = \{ {p}_{1}^{A} , {p}_{2}^{A} , {p}_{3}^{A} , … , {p}_{N}^{A} \} \qquad ( 1 )$$

Furthermore, in the present embodiment, the self-position estimation device 20 calculates N first feature amounts as one or more feature amounts from the first image. The N first feature amounts correspond to the N first feature points on a one-to-one basis. Each of the N first feature amounts is a feature amount of a corresponding first feature point among the N first feature points. Then, the self-position estimation device 20 generates a first feature amount list (D^{A}) represented by Expression (2).

$${D}_{A} = \{ {d}_{1}^{A} , {d}_{2}^{A} , {d}_{3}^{A} , … , {d}_{N}^{A} \} \qquad ( 2 )$$

In Expression (2), d^{A}ᵢ represents a feature amount of p^{A}ᵢ. i is any integer greater than or equal to one and less than or equal to N.

Furthermore, in the present embodiment, the self-position estimation device 20 detects M second feature points as one or a plurality of feature points from the second image. Then, the self-position estimation device 20 generates a feature point list (P_{B}) represented by Expression (3).

$${P}_{B} = \{ {p}_{1}^{B} , {p}_{2}^{B} , {p}_{3}^{B} , ⋯ , {p}_{M}^{B} \} \qquad ( 3 )$$

Furthermore, in the present embodiment, the self-position estimation device 20 calculates M second feature amounts as one or more feature amounts from the second image. The M second feature amounts correspond to the M second feature points on a one-to-one basis. Each of the M second feature amounts is a feature amount of a corresponding second feature point among the M second feature points. Then, the self-position estimation device 20 generates a second feature amount list (D_{B}) represented by Expression (4).

$${D}_{B} = \{ {d}_{1}^{B} , {d}_{2}^{B} , {d}_{3}^{B} , ⋯ , {d}_{M}^{B} \} \qquad ( 4 )$$

In Expression (4), d^{B}ⱼ represents a feature amount of p^{B}ⱼ. j is any integer greater than or equal to one and less than or equal to M.

In the case of the example of FIG. 4, the self-position estimation device 20 associates each of the three feature points (p^{A}₁, p^{A}₂, p^{A}₃) detected from the first image with any feature point estimated to be the same object among the three feature points (p^{B}₁, p^{B}₂, p^{B}₃) detected from the second image. In the case of the example of FIG. 4, the self-position estimation device 20 associates a feature point (p^{A}₁) that is an image of q₁ in the first image with a feature point (p^{B}₁) that is an image of q₁ in the second image. Furthermore, in the case of the example of FIG. 4, the self-position estimation device 20 associates a feature point (p^{A}₂) that is an image of q₂ in the first image with a feature point (p^{B}₂) that is an image of q₂ in the second image. Furthermore, in the case of the example of FIG. 4, the self-position estimation device 20 associates a feature point (p^{A}₃) that is an image of q₃ in the first image with a feature point (p^{B}₃) that is an image of q₃ in the second image.

In the present embodiment, the self-position estimation device 20 generates a corresponding point list for the first image. The corresponding point list represents corresponding point pairs. The corresponding point pair includes any first feature point of the N first feature points and the associated second feature point among the M second feature points.

For example, the corresponding point list may include a value indicating whether a first feature point and a second feature point are a corresponding point pair for all combinations of the N first feature points and the M second feature points.

In the present embodiment, the self-position estimation device 20 generates a corresponding point list (M^{A,B}) expressed by Expression (5) for the first image.

$${M}^{A , B} = \{ {m}_{1 , 1}^{A , B} , {m}_{1 , 2}^{A , B} , ⋯ , {m}_{2 , 1}^{A , B} , {m}_{2 , 2}^{A , B} , ⋯ , {m}_{N , M}^{A , B} \} \qquad ( 5 )$$

In Expression (5), m^{A,B}_{i,j} is a value indicating whether there is a corresponding point pair including p p^{B}ⱼ. That is, m^{A,B}_{i,j} indicates whether p^{A}ᵢ and p^{B}ⱼ are associated as the same object.

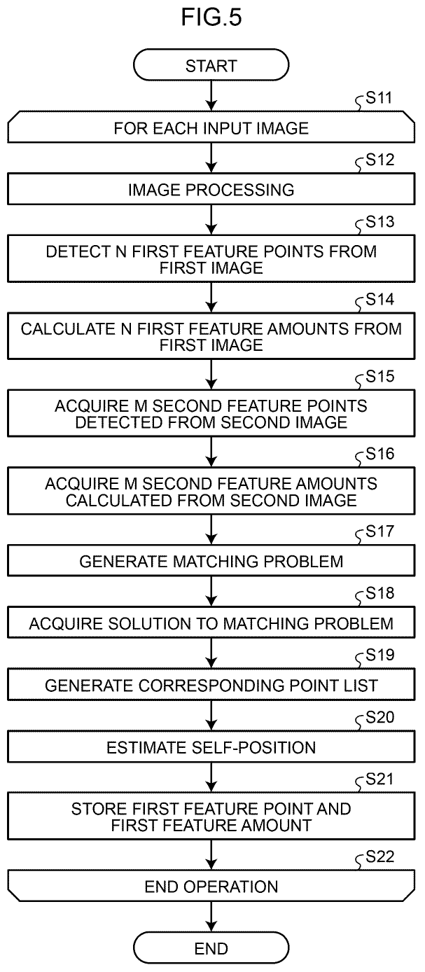

FIG. 5 is a flowchart illustrating a flow of processing of the self-position estimation device 20 according to the embodiment. The self-position estimation device 20 executes processing in the flow illustrated in FIG. 5.

The self-position estimation device 20 acquires an input image from the camera 12 at predetermined time intervals. Every time the input image is acquired, the self-position estimation device 20 executes processing from S12 to S21 with the acquired input image as the first image (loop processing between S11 and S22).

First, in S12, the self-position estimation device 20 performs an image process on the first image. For example, the self-position estimation device 20 converts the RAW image into an RGB image or a monochrome image, and performs demosaic, noise removal, image quality adjustment, distortion correction processing, shape conversion processing, and the like on the first image.

Subsequently, in S13, the self-position estimation device 20 detects N first feature points from the first image. Each of the N first feature points is a feature point included in the first image.

Subsequently, in S14, the self-position estimation device 20 calculates N first feature amounts from the first image. The N first feature amounts correspond to the N first feature points detected in S13 on a one-to-one basis. Each of the N first feature amounts is a feature amount at a corresponding first feature point among the N first feature points.

Subsequently, in S15, the self-position estimation device 20 acquires M second feature points detected from the second image. The second image is an input image acquired before the first image. For example, the second image may be an input image acquired immediately before the first image. Furthermore, for example, the second image may be a key frame image registered before the first image.

Subsequently, in S16, the self-position estimation device 20 acquires M second feature amounts calculated from the second image. The M second feature amounts correspond to the M second feature points acquired in S15 on a one-to-one basis. Each of the M second feature amounts is a feature amount at a corresponding second feature point among the M second feature points.

Subsequently, in S17, the self-position estimation device 20 generates a matching problem based on the N first feature points and the N first feature amounts, and the M second feature points and the M second feature amounts. The matching problem is a combination optimization problem in which any second feature point estimated to represent the same object among the M second feature points is associated with each of the N first feature points.

Subsequently, in S18, the self-position estimation device 20 acquires a solution to the matching problem. The self-position estimation device 20 provides the matching problem to the solver device 14 and causes the solver device to solve the matching problem. Then, the self-position estimation device 20 acquires a solution to the matching problem from the solver device 14. Furthermore, in a case where the matching problem is a problem that can be easily solved, the self-position estimation device 20 may solve the matching problem by itself.

Subsequently, in S19, the self-position estimation device 20 generates a corresponding point list representing corresponding point pairs based on the solution to the matching problem. The corresponding point pair includes any first feature point of the N first feature points and the associated second feature point among the M second feature points.

Subsequently, in S20, the self-position estimation device 20 estimates the self-position, which is the location of the camera 12 that has captured the first image in the three-dimensional space, based on the corresponding point list. The self-position estimation device 20 may estimate the posture of the camera 12 in the three-dimensional space. Then, the self-position estimation device 20 provides the self-position estimated for the first image to the control device 22.

Subsequently, in S21, the self-position estimation device 20 stores the N first feature points and the N first feature amounts detected from the first image as the M second feature points and the M second feature amounts detected from the second image. As a result, the self-position estimation device 20 can acquire the M second feature points and the M second feature amounts in the process on the next first image.

Note that, in a case where the second image is a key frame image registered before the first image, the self-position estimation device 20 stores N first feature points and N first feature amounts as M second feature points and M second feature amounts on condition that the first image is registered as the key frame image. That is, in a case where the second image is a key frame image registered before the first image, the self-position estimation device 20 does not execute the processing of S21 if the first image is not a key frame image.

The self-position estimation device 20 repeats the processing from S12 to S21 for each input image until the operation of the moving body ends (S22). Then, in a case where the operation of the moving body is ended, the self-position estimation device 20 ends this flow.

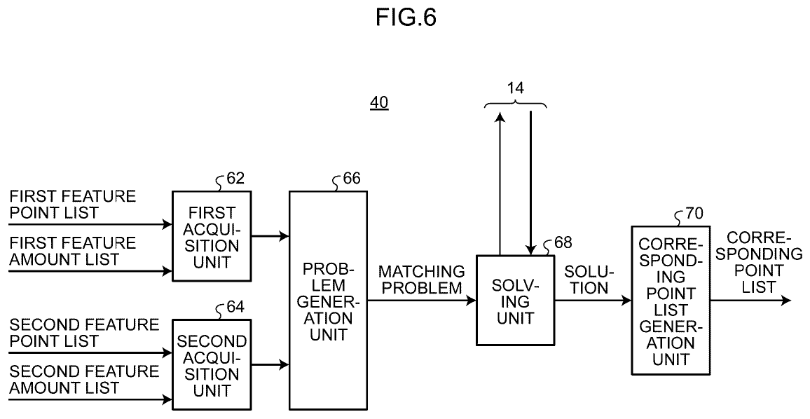

FIG. 6 is a diagram illustrating a functional configuration of the matching unit 40.

The matching unit 40 includes a first acquisition unit 62, a second acquisition unit 64, a problem generation unit 66, a solving unit 68, and a corresponding point list generation unit 70.

The first acquisition unit 62 acquires a first feature point list representing N first feature points detected from the first image. In addition, the first acquisition unit 62 acquires a first feature amount list representing N first feature amounts calculated from the first image. The first acquisition unit 62 provides the N first feature points represented by the first feature point list and the N first feature amounts represented by the first feature amount list to the problem generation unit 66.

The second acquisition unit 64 acquires a second feature point list representing the M second feature points detected from the second image. In addition, the first acquisition unit 62 acquires a second feature amount list representing M second feature amounts calculated from the second image. The second acquisition unit 64 provides the problem generation unit 66 with M second feature points represented by the second feature point list and M second feature amounts represented by the second feature amount list.

The problem generation unit 66 generates a matching problem based on the N first feature points and the N first feature amounts, and the M second feature points and the M second feature amounts. The problem generation unit 66 provides the generated matching problem to the solving unit 68.

The solving unit 68 provides the matching problem to the solver device 14 to obtain a solution to the matching problem. In a case where the solver device 14 is a quadratic unconstrained binary optimization (QUB) solver, the solving unit 68 converts the objective function included in the matching problem into a QUBO equation and provides the QUBO equation to the solver device 14. Furthermore, in a case where the solver device 14 is an Ising problem, the solving unit 68 converts an objective function included in the matching problem into an Ising model and provides the Ising model to the solver device 14.

In addition, in a case where the matching problem is a problem that can be easily solved, the solving unit 68 may solve the matching problem by itself without providing the matching problem to the solver device 14. The solving unit 68 provides the obtained solution to the corresponding point list generation unit 70.

The corresponding point list generation unit 70 generates a corresponding point list representing corresponding point pairs based on the solution to the matching problem. Then, the corresponding point list generation unit 70 provides the generated corresponding point list to the estimation unit 42.

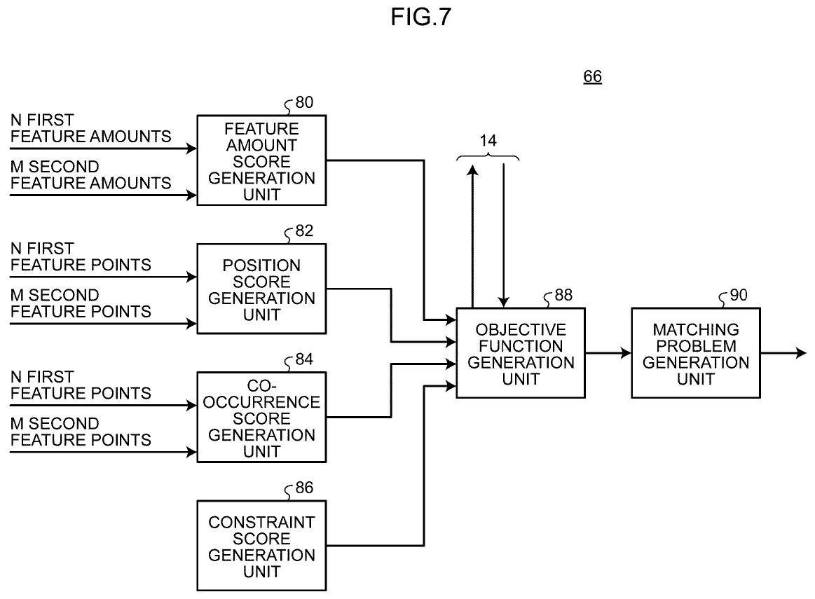

FIG. 7 is a diagram illustrating a functional configuration of the problem generation unit 66.

The problem generation unit 66 includes a feature amount score generation unit 80, a position score generation unit 82, a co-occurrence score generation unit 84, a constraint score generation unit 86, an objective function generation unit 88, and a matching problem generation unit 90.

The feature amount score generation unit 80 acquires N first feature amounts calculated from the first image and M second feature amounts calculated from the second image. The feature amount score generation unit 80 generates (N×M) feature amount scores based on the N first feature amounts and the M second feature amounts.

In the present embodiment, the (N×M) feature amount scores are disposed in a feature amount score matrix (R) of N rows×M columns. In the present embodiment, the feature amount score of the i-th row×the j-th column among the (N×M) feature amount scores is represented as Rᵢⱼ.

The feature amount score (Rᵢⱼ) of the i-th row×the j-th column is a value depending on the similarity between the feature amount (that is, the i-th first feature amount) of the i-th first feature point and the feature amount (that is, the j-th second feature amount) of the j-th second feature point.

More specifically, in a case where the matching problem is a combination optimization problem that maximizes the objective function, the feature amount score (Rᵢⱼ) of the i-th row×the j-th column has a larger value as the similarity between the feature amount (that is, the i-th first feature amount) of the i-th first feature point and the feature amount (that is, the j-th second feature amount) of the j-th second feature point is larger. In the case that the matching problem is the combination optimization problem that minimizes the objective function, the feature amount score (Rᵢⱼ) of the i-th row×the j-th column has a smaller value as the similarity between the feature amount (that is, the i-th first feature amount) of the i-th first feature point and the feature amount (that is, the j-th second feature amount) of the j-th second feature point is larger.

The similarity representing the degree of similarity between the i-th first feature amount and the j-th second feature amount has a different calculation method depending on an algorithm for calculating the feature amount. For example, in a case where the first feature amount and the second feature amount are calculated by the algorithm of BRIEF, the similarity between the i-th first feature amount and the j-th second feature amount may be a Hamming distance between the i-th first feature amount and the j-th second feature amount. For example, the similarity between the i-th first feature amount and the j-th second feature amount may be cosine similarity between the i-th first feature amount and the j-th second feature amount. Furthermore, the similarity between the i-th first feature amount and the j-th second feature amount may be a likelihood between the i-th first feature amount and the j-th second feature amount calculated by a neural network, a support vector machine (SVM)), or the like.

In addition, for each of the (N×M) feature amount scores, a value calculated by the method as described above may be normalized to a value within a predetermined range. For example, each of the (N×M) feature amount scores may be normalized within a range greater than or equal to −1 and less than or equal to +1. Furthermore, each of the (N×M) feature amount scores may be normalized within a predetermined range on a nonlinear curve such as a Log curve. Furthermore, for each of the (N×M) feature amount scores, an offset value may be added to or subtracted from the value calculated by the method as described above. Furthermore, each of the (N×M) feature amount scores may be discretized into a binary value such as −1 or +1, or a predetermined number of discrete values.

The position score generation unit 82 acquires N first feature points detected from the first image and M second feature points detected from the second image. The feature amount score generation unit 80 generates (N×M) feature amount scores based on the N first feature points and the M second feature points.

The (N×M) feature amount scores are disposed in a position score matrix (S) of N rows×M columns. In the present embodiment, the position score of the i-th row×the j-th column among the (N×M) position scores is represented as Sᵢⱼ.

The position score (Sᵢⱼ) of the i-th row×the j-th column is a value depending on the estimated distance between the estimated position of the j-th second feature point at the time of the first image and the position of the i-th first feature point.

More specifically, in a case where the matching problem is a combination optimization problem that maximizes the objective function, the position score (Sᵢⱼ) of the i-th row×the j-th column has a larger value as the estimated distance between the estimated position of the j-th second feature point at the time of the first image and the position of the i-th first feature point is shorter. In a case where the matching problem is a combination optimization problem that minimizes the objective function, the position score (Sᵢⱼ) of the i-th row×the j-th column has a smaller value as the estimated distance between the estimated position of the j-th second feature point estimated at the time of the first image and the position of the i-th first feature point is shorter.

For example, the distance between the estimated position of the j-th second feature point at the time of the first image and the position of the i-th first feature point is the L2 norm of the difference between the estimated position of the j-th second feature point at the time of the first image and the position of the i-th first feature point. Furthermore, the position score generation unit 82 may calculate a provisional corresponding point list by matching only the feature amounts, and estimate the estimated position of the j-th second feature point at the time of the first image based on the provisional corresponding point list. In this case, the position score generation unit 82 may detect the first feature point corresponding point paired with the j-th second feature point in the provisional corresponding point list, and estimate the estimated position of the j-th second feature point at the time of the first image by performing linear interpolation or the like on the amount of movement of the detected first feature point.

Further, the position score generation unit 82 may calculate an optical flow from the second image to the first image, and estimate the estimated position of the j-th second feature point at the time of the first image based on the optical flow at the position of the j-th second feature point. Furthermore, the position score generation unit 82 may estimate the self-position and the posture using information output from a sensor other than the camera 12 such as a global positioning system (GPS) or an inertial measurement unit (IMU), and estimate the estimated position of the j-th second feature point at the time of the first image based on the estimated self-position and the posture.

In addition, the position score generation unit 82 may estimate the estimated image position of the j-th second feature point at the time of the first image using a Kalman filter or the like based on the tracking result of the feature point in the past input image. Furthermore, for example, the position score generation unit 82 may estimate the self-position of the first image from the tracking result of the self-position of the past frame, and may estimate the estimated image position of the j-th second feature point at the time of the first image by mapping the feature point in the past frame to the first image in which the self-position is estimated. Note that the position score generation unit 82 may estimate the estimated position of the j-th second feature point at the time of the first image by another estimation method other than the above-described estimation method.

Furthermore, in a case where the first image and the second image are images captured by the camera 12 moved parallel to the optical axis, the position score generation unit 82 may include an angle component in the position score (Sᵢⱼ) of the i-th row×the j-th column. For example, the position score generation unit 82 calculates an angular difference between a line connecting the three-dimensional position of the j-th second feature point and the three-dimensional position of the i-th first feature point and a line radially extending from the vanishing point as an angle component. In a case where the matching problem is a combination optimization problem that maximizes the objective function, the position score (Sᵢⱼ) of the i-th row×the j-th column has a larger value as the angle component is smaller. In a case where the matching problem is a combination optimization problem that minimizes the objective function, the position score (Sᵢⱼ) of the i-th row×the j-th column has a smaller value as the angle component is smaller.

In each of the (N×M) position scores, the value calculated by the above method may be normalized to a value within a predetermined range. For example, each of the (N×M) position scores may be normalized to within a range greater than or equal to −1 and less than or equal to +1. Furthermore, each of the (N×M) position scores may be normalized within a predetermined range on a nonlinear curve such as a Log curve. Furthermore, for each of the (N×M) position scores, an offset value may be added to or subtracted from the value calculated by the above method. Furthermore, each of the (N×M) position scores may be discretized into a binary value such as −1 or +1, or a predetermined number of discrete values.

The co-occurrence score generation unit 84 acquires N first feature points detected from the first image and M second feature points detected from the second image. The co-occurrence score generation unit 84 generates ((N×M)×(N×M)) co-occurrence scores based on the N first feature points and the M second feature points.

The ((N×M)×(N×M)) co-occurrence scores are disposed in a co-occurrence score matrix (T) of (N×M) rows×(N×M) columns.

The (N×M) rows in the co-occurrence score matrix (T) represent all combinations of the N first feature points and the M second feature points. In the present embodiment, a row representing a (i,j) set in the co-occurrence score matrix (T) represents a combination of the i-th first feature point and the j-th second feature point.

The (N×M) columns in the co-occurrence score matrix (T) represent all combinations of the N first feature points and the M second feature points. In the present embodiment, a column representing a (i′,j′) set in the co-occurrence score matrix (T) represents a combination of the i′-th first feature point and the j′-th second feature point. i′ represents any integer greater than or equal to one and less than or equal to N. j′ represents any integer greater than or equal to one and less than or equal to M.

In the present embodiment, the co-occurrence score of the row representing the (i,j) set and the column representing the (i′,j′) set among the ((N×M)×(N×M)) co-occurrence scores is represented as T_{ij,i′j′}.

The co-occurrence score (T_{ij,i′j′}) is a value representing validity of simultaneous existence of a corresponding point pair of the i-th first feature point and the j-th second feature point and a corresponding point pair of the i′-th first feature point and the j′-th second feature point.

For example, the co-occurrence score (T_{ij,i′j′}) is a value depending on the degree of approximation of the first positional relationship between the image position of the i-th first feature point and the image position of the j-th second feature point and the second positional relationship between the image position of the i′-th first feature point and the image position of the j′-th second feature point.

For example, in a case where the matching problem is a combination optimization problem that maximizes the objective function, the co-occurrence score (T_{ij,i′j′}) is larger as the first positional relationship between the image position of the i-th first feature point and the image position of the j-th second feature point and the second positional relationship between the image position of the i′-th first feature point and the image position of the j′-th second feature point are closer. Furthermore, in a case where the matching problem is a combination optimization problem that minimizes the objective function, the co-occurrence score (T_{ij,i′j′}) is smaller as the first positional relationship and the second positional relationship are closer.

For example, in a case where the first straight line connecting the image position of the i-th first feature point and the image position of the j-th second feature point does not intersect the second straight line connecting the image position of the i′-th first feature point and the image position of the j′-th second feature point, the degree of approximation may be a value indicating that the first positional relationship and the second positional relationship are close to each other. For example, in a case where the first straight line and the second straight line intersect each other, the degree of approximation may be a value indicating that the first positional relationship and the second positional relationship are not close to each other.

For example, the degree of approximation may be a value depending on a vector direction difference between a direction of a first vector from the image position of the i-th first feature point to the image position of the j-th second feature point and a direction of a second vector from the image position of the i′-th first feature point to the image position of the j′-th second feature point. For example, the degree of approximation may be a cosine similarity between the first vector and the second vector. For example, the degree of approximation may be an inner product of the first vector and the second vector.

For example, as illustrated in FIG. 4, a case where q₁ and q₂ that are stationary bodies exist in a three-dimensional space is considered. In the first image, q₂ (the first feature point (p₂^{A}) in the first image) is imaged to right of q₁ (the feature point (p₁^{A}) in the first image). Also in the second image, q₂ (the second feature point (p₂^{B}) in the second image) is imaged to right of q₁ (the feature point (p₁^{B}) in the second image). As described above, in a case where the object is a stationary body and the amount of movement of the camera 12 is small, the positional relationship between q₁ and q₂ in the image is maintained between the first image and the second image.

In a case where such a condition is satisfied, if the positional relationship between pᵢ^{A} and pⱼ^{B} in the first image and the positional relationship between p_{i′}^{A} and p_{j′}^{B} in the second image are maintained, it can be said that it is appropriate that the two corresponding point pairs are established simultaneously. However, if the positional relationship between pᵢ^{A} and pⱼ^{B} in the first image and the positional relationship between p_{i′}^{A} and p_{j′}^{B} in the second image are not maintained, it can be said that it is not appropriate that the two corresponding point pairs are established simultaneously. Therefore, the co-occurrence score (T_{ij,i′j′}) is set to a value depending on the degree of approximation of the first positional relationship between the image position of the i-th first feature point and the image position of the j-th second feature point and the second positional relationship between the image position of the i′-th first feature point and the image position of the j′-th second feature point, whereby a score according to the validity of such simultaneous establishment can be expressed.

Furthermore, for example, the co-occurrence score (T_{ij,i′j′}) may be a value obtained by combining the first degree of approximation and the second degree of approximation. The first degree of approximation represents the degree of approximation between the first positional relationship between the image position of the i-th first feature point and the image position of the j-th second feature point and the second positional relationship between the image position of the i′-th first feature point and the image position of the j′-th second feature point. The second degree of approximation represents the degree of approximation of the third positional relationship between the estimated image position of the j-th second feature point at the time of the first image and the image position of the j-th second feature point, and the fourth positional relationship between the image position of the i′-th first feature point and the image position of the j′-th second feature point. The co-occurrence score (T_{ij,i′j′}) may be a value combined by averaging the first degree of approximation and the second degree of approximation. Furthermore, the co-occurrence score (T_{ij,i′j′}) may be a value combined by weighting and averaging the first degree of approximation and the second degree of approximation. Since such a co-occurrence score (T_{ij,i′j′}) includes the estimated image position of the j-th second feature point at the time of the first image as an element, it is possible to more accurately express the validity of simultaneous establishment. The fourth positional relationship may be the same as the second positional relationship.

In a case where the first condition is satisfied, the co-occurrence score (T_{ij,i′j′}) may be a value depending on the degree of approximation as described above. In addition, in a case where the first condition is satisfied, the co-occurrence score (T_{ij,i′j′}) may be a value depending on a difference in amount of movement between the first amount of movement from the image position of the i-th first feature point to the image position of the j-th second feature point and the second amount of movement from the image position of the i′-th first feature point to the image position of the j′-th second feature point. In a case where the first condition is satisfied, the co-occurrence score (T_{ij,i′j′}) may be a value obtained by combining the first difference in amount of movement and the second difference in amount of movement by averaging, weighting and averaging, or the like. The first difference in amount of movement represents a difference in amount of movement from the image position of the i-th first feature point to the image position of the j-th second feature point. The second difference in amount of movement represents a difference in amount of movement between a third amount of movement from the estimated image position of the j-th second feature point at the time of the first image to the image position of the j-th second feature point and a fourth amount of movement from the image position of the i′-th first feature point to the image position of the j′-th second feature point.

The first condition is a condition that a distance between the image position of the i-th first feature point and the image position of the i′-th first feature point is less than or equal to a predetermined distance. The first condition may be a condition that a distance between the image position of the i-th first feature point and the image position of the i′-th first feature point is less than or equal to a predetermined distance, and a distance between the image position of the j-th second feature point and the image position of the j′-th second feature point is less than or equal to a predetermined distance.

For example, in a case where the first condition is satisfied and the matching problem is a combination optimization problem that maximizes the objective function, the co-occurrence score (T_{ij,i′j′}) is larger as the difference in amount of movement is smaller. For example, in a case where the first condition is satisfied and the matching problem is a combination optimization problem that minimizes the objective function, the co-occurrence score (T_{ij,i′j′}) is smaller as the difference in amount of movement is smaller. However, in a case where the first condition is not satisfied, the co-occurrence score (T_{ij,i′j′}) is a value indicating that it is not appropriate that the corresponding point pair of the i-th first feature point and the j-th second feature point and the corresponding point pair of the i′-th first feature point and the j′-th second feature point exist at the same time.

In a case where the second condition is satisfied, the co-occurrence score (T_{ij,i′j′}) may be a value depending on a correlation between a size and an amount of movement from a vanishing point on the image of the first object represented by a corresponding point pair of the i-th first feature point and the j-th second feature point and a size and an amount of movement from a vanishing point on the image of the second object represented by a corresponding point pair of the i′-th first feature point and the j′-th second feature point. The second condition is a condition that the above is a condition that the first image and the second image are images captured by the camera 12 moved in parallel with respect to the optical axis, and the movement direction from the i-th first feature point to the j-th second feature point and the movement direction from the i′-th first feature point to the j′-th second feature point are the radiation direction from the vanishing point. For example, the co-occurrence score generation unit 84 determines whether the second condition is satisfied based on the estimation result of the self-position of the external sensor or the past input image.

For example, in a case where the second condition is satisfied and the matching problem is a combination optimization problem that maximizes the objective function, the co-occurrence score (T_{ij,i′j′}) is larger as the correlation is larger. Furthermore, for example, in a case where the second condition is satisfied and the matching problem is a combination optimization problem that minimizes the objective function, the co-occurrence score (T_{ij,i′j′}) is smaller as the correlation is larger. However, in a case where the second condition is not satisfied, the co-occurrence score (T_{ij,i′j′}) is a value indicating that it is not appropriate that the corresponding point pair of the i-th first feature point and the j-th second feature point and the corresponding point pair of the i′-th first feature point and the j′-th second feature point exist at the same time.

In a case where the third condition is satisfied, the co-occurrence score (T_{ij,i′j′}) may be a value depending on a difference in movement between the movement direction and the amount of movement of the first object represented by the corresponding point pair of the i-th first feature point and the j-th second feature point and the movement direction and the amount of movement of the second object represented by the corresponding point pair of the i′-th first feature point and the j′-th second feature point. The third condition is a condition that the first image and the second image are images captured by the camera 12 having an optical axis turned. For example, the co-occurrence score generation unit 84 determines whether the third condition is satisfied based on the estimation result of the self-position of the external sensor or the past input image.

For example, in a case where the third condition is satisfied and the matching problem is a combination optimization problem that maximizes the objective function, the co-occurrence score (T_{ij,i′j′}) is larger as the difference in movement is smaller. Furthermore, for example, in a case where the third condition is satisfied and the matching problem is a combination optimization problem that minimizes the objective function, the co-occurrence score (T_{ij,i′j′}) is smaller as the difference in movement is smaller. However, in a case where the third condition is not satisfied, the co-occurrence score (T_{ij,i′j′}) is a value indicating that it is not appropriate that the corresponding point pair of the i-th first feature point and the j-th second feature point and the corresponding point pair of the i′-th first feature point and the j′-th second feature point exist at the same time.

The second condition and the third condition are satisfied in a case where the amount of movement of the camera 12 is minute, there is almost no rotation of the camera 12 in the roll direction, and most of the objects are stationary bodies. For example, in a case where the amount of movement of the camera 12 is large, the positional relationship of the stationary body in the image is switched in a case where two images captured from the front and the rear of the object are compared. In addition, in a case where the rotation in the roll direction is large and the camera 12 is rolled by 180 degrees, the positional relationship of the stationary body in the image is switched. Therefore, a positional relationship between the moving body and the stationary body or between the moving body and another moving body is not guaranteed. However, the positional relationship between the feature point and the feature point in the same moving body is guaranteed. In addition, in a case where the image-capture interval is short and the amount of movement of the moving body is minute, there is a high possibility that the positional relationship is guaranteed relatively.

In the second condition and the third condition, it is assumed that the rotation of the position where the first image and the second image are captured in the roll direction is small. For example, in a case where the moving body is a device that greatly performs roll rotation in a short period of time such as a drone, and a change in the roll direction can be acquired by an external sensor or the like, the self-position estimation device 20 may correct the roll direction with respect to the input image before detecting the feature point, and calculate the co-occurrence score (T_{ij,i′j′}). Furthermore, in a case where the change in the roll direction cannot be acquired, the self-position estimation device 20 may calculate the roll rotation amount for correction from the provisional self-position using the result of matching of only the feature amount, correct the roll direction with respect to the input image based on the roll rotation amount for correction, and calculate the co-occurrence score (T_{ij,i′j′}).

In addition, the co-occurrence score generation unit 84 may simultaneously determine the second condition and the third condition, and may calculate, as the co-occurrence score (T_{ij,i′j′}), a value depending on the correlation and the difference in movement in a case where each condition is satisfied.

In addition, for each of the ((N×M)×(N×M)) co-occurrence scores, the value calculated by the method as described above may be normalized to a value within a predetermined range. For example, each of the ((N×M)×(N×M)) co-occurrence scores may be normalized to within a range greater than or equal to −1 and less than or equal to +1. In addition, each of the ((N×M)×(N×M)) co-occurrence scores may be normalized within a predetermined range on a nonlinear curve such as a Log curve. In addition, for each of the ((N×M)×(N×M)) co-occurrence scores, an offset value may be added to or subtracted from the value calculated by the above method. In addition, each of the ((N×M)×(N×M)) co-occurrence scores may be discretized into a binary value such as −1 or +1, or a predetermined number of discrete values.

The constraint score generation unit 86 generates ((N×M)×(N×M)) constraint scores based on, for example, a preset setting value. In the present embodiment, the ((N×M)×(N×M)) constraint scores are disposed in a constraint score matrix (U) of (N×M) rows×(N×M) columns.

(N×M) rows in the constraint score matrix (U) represent all combinations of the N first feature points and the M second feature points. In the present embodiment, a row representing a (i,j) set in the constraint score matrix (U) represents a combination of the i-th first feature point and the j-th second feature point.

(N×M) columns in the constraint score matrix (U) represent all combinations of the N first feature points and the M second feature points. In the present embodiment, a column representing a (i′,j′) set in the constraint score matrix (U) represents a combination of the i′-th first feature point and the j′-th second feature point.

In the present embodiment, the constraint score of the row representing the set of (i,j) and the column representing the set of (i′,j′) among the ((N×M)×(N×M)) constraint scores is represented as U_{ij,i′j′}.

The constraint score (U_{ij,i′j′}) of the row representing the set of (i,j) and the column representing the set of (i′,j′) indicates whether the corresponding point pair of the i-th first feature point and the j-th second feature point and the corresponding point pair of the i′-th first feature point and the j′-th second feature point can be established at the same time.

In the case of i=i′, in a case where j=j′, the constraint score (U_{ij,i′j′}) represents a value indicating that it can be established, and in a case where j≠j′, it represents a value indicating that it cannot be established. In addition, in a case where i≠i′, in a case where j=j′, the constraint score (U_{ij,i′j′}) represents a value indicating that it cannot be established, and in a case where j≠j′, it represents a value indicating that it can be established.

For example, in a case where the matching problem is an optimization problem that maximizes the objective function, the constraint score (U_{ij,i′j′}) is a positive predetermined value such as 1 in a case where the corresponding point pair of the i-th first feature point and the j-th second feature point and the corresponding point pair of the i′-th first feature point and the j′-th second feature point can be established at the same time, and is zero or a negative predetermined value in a case where they cannot be established.

Furthermore, for example, in a case where the matching problem is an optimization problem that minimizes the objective function, the constraint score (U_{ij,i′j′}) is a negative predetermined value such as −1 in a case where the corresponding point pair of the i-th first feature point and the j-th second feature point and the corresponding point pair of the i′-th first feature point and the j′-th second feature point can be established at the same time, and is zero or a positive predetermined value in a case where they cannot be established.

In such a constraint score matrix (U), the solution to the matching problem can be limited so that the number of second feature points corresponding to the N first feature points is zero or one and the number of first feature points corresponding to the M second feature points is zero or one.

The objective function generation unit 88 acquires a feature amount score matrix (R) of N rows×M columns from the feature amount score generation unit 80. The objective function generation unit 88 acquires a position score matrix (S) of N rows×M columns from the position score generation unit 82. The objective function generation unit 88 acquires a co-occurrence score matrix (T) of (N×M) rows×(N×M) columns from the co-occurrence score generation unit 84. The objective function generation unit 88 acquires the constraint score matrix (U) of (N×M) rows×(N×M) columns from the constraint score generation unit 86.

Then, the objective function generation unit 88 generates an objective function (H(x)) as shown in Expression (6).

$$H ( x ) = {C}_{R} \cdot {\sum }_{i , j} {R}_{ij} {x}_{ij} + {C}_{S} \cdot {\sum }_{i , j} {S}_{ij} {x}_{i} + {C}_{T} \cdot {\sum }_{i , j , {i}^{′} , {j}^{′}} {T}_{i , j , {i}^{′} , {j}^{′}} {x}_{ij} {x}_{{i}^{′} , {j}^{′}} + {C}_{U} \cdot {\sum }_{i , j , {i}^{′} , {j}^{′}} {U}_{i , j , {i}^{′} , {j}^{′}} {x}_{ij} {x}_{{i}^{′} , {j}^{′}} \qquad ( 6 )$$

The objective function (H(x)) includes (N×M) decision variables. In the present embodiment, the (N×M) decision variables are disposed in a variable matrix of N rows and M columns.

The objective function (H(x)) is minimized or maximized in a case where all of the (N×M) decision variables are set to correct answer values. More specifically, in a case where the matching problem is a combination optimization problem that maximizes the objective function (H(x)), the objective function (H(x)) has a maximum value in a case where all of the (N×M) decision variables are set to correct answer values. In a case where the matching problem is a combination optimization problem that minimizes the objective function (H(x)), the objective function (H(x)) has a minimum value in a case where all of the (N×M) decision variables are set to correct answer values.

The decision variable of the i-th row×the j-th column among the (N×M) decision variables indicates whether the i-th first feature point and the j-th second feature point are a corresponding point pair. In a case where the i-th first feature point and the j-th second feature point represent the same object, the correct answer value of the decision variable of the i-th row×the j-th column among the (N×M) decision variables is a value indicating that the i-th first feature point and the j-th second feature point are a corresponding point pair. Further, in a case where the i-th first feature point and the j-th second feature point do not represent the same object, the correct answer value in the decision variable of the i-th row×the j-th column is a value indicating that the i-th first feature point and the j-th second feature point are not the corresponding point pair.

In the present embodiment, the objective function (H(x)) includes a term in which the decision variable of i-th row×the j-th column is multiplied by the feature amount score (Rᵢⱼ) of the i-th row×the j-th column in the feature amount score matrix (R) shown in Expression (7).

$${C}_{R} \cdot {\sum }_{i , j} {R}_{ij} {x}_{ij} \qquad ( 7 )$$

C_{R} in Expression (7) is a predetermined constant.

The feature amount score (Rᵢⱼ) of the i-th row×the j-th column is a value depending on the similarity between the feature amount of the i-th first feature point and the feature amount of the j-th second feature point. The similarity between the feature amount of the i-th first feature point and the feature amount of the j-th second feature point represents validity of the i-th first feature point and the j-th second feature point are the same object, that is, validity that the i-th first feature point and the j-th second feature point being a corresponding point pair.

Therefore, in a case where the matching problem is a combination optimization problem that maximizes the objective function (H(x)), Expression (7) has a maximum value in a case where all of the (N×M) decision variables are set to correct answer values. In a case where the matching problem is a combination optimization problem that minimizes the objective function (H(x)), Expression (7) has a minimum value in a case where all of the (N×M) decision variables are set to correct answer values.

In the present embodiment, the objective function (H(x)) includes a term in which the decision variable of i-th row×the j-th column is multiplied by the position score (Sᵢⱼ) of i-th row×the j-th column in the position score matrix (S) shown in Expression (8).

$${C}_{S} \cdot {\sum }_{i , j} {S}_{ij} {x}_{ij} \qquad ( 8 )$$

C_{S} in Expression (8) is a predetermined constant.

The position score (Sᵢⱼ) of the i-th row×the j-th column is a value depending on the estimated distance between the estimated position of the j-th second feature point at the time of the first image and the position of the i-th first feature point. The estimated distance between the estimated position of the j-th second feature point at the time of the first image and the position of the i-th first feature point represents validity of the i-th first feature point and the j-th second feature point being the same object, that is, validity of the i-th first feature point and the j-th second feature point being a corresponding point pair.

Therefore, in a case where the matching problem is a combination optimization problem that maximizes the objective function (H(x)), Expression (8) has a maximum value in a case where all of the (N×M) decision variables are set to correct answer values. In a case where the matching problem is a combination optimization problem that minimizes the objective function (H(x)), Expression (8) has a minimum value in a case where all of the (N×M) decision variables are set to correct answer values.

In the present embodiment, the objective function (H(x)) includes a term in which the decision variable of i-th row×the j-th column is multiplied by the decision variable of the i′-th row×the j′-th column, and the co-occurrence score (T_{ij,i′j′}) of the row representing the set of (i,j) and the column representing the set of (i′,j′) in the co-occurrence score matrix (T) shown in Expression (9).

$${C}_{T} \cdot {\sum }_{i , j , {i}^{′} , {j}^{′}} {T}_{ij , {i}^{′} , {j}^{′}} {x}_{ij} {x}_{{i}^{′} , {j}^{′}} \qquad ( 9 )$$

CT in Expression (9) is a predetermined constant.

The co-occurrence score (T_{ij,i′j′}) of the row representing the set of (i,j) and the column representing the set of (i′,j′) is a value representing validity of simultaneous existence of the corresponding point pair of the i-th first feature point and the j-th second feature point and the corresponding point pair of the i′-th first feature point and the j′-th second feature point. That is, the co-occurrence score (T_{ij,i′j′}) represents validity of the i-th first feature point and the j-th second feature point representing the same first object and the i′-th first feature point and the j′-th second feature point representing the same second object.

Therefore, in a case where the matching problem is a combination optimization problem that maximizes the objective function (H(x)), Expression (9) has a maximum value in a case where all of the (N×M) decision variables are set to correct answer values. In a case where the matching problem is a combination optimization problem that minimizes the objective function (H(x)), Expression (9) has a minimum value in a case where all of the (N×M) decision variables are set to correct answer values.

In the present embodiment, the objective function (H(x)) includes a term in which the decision variable of i-th row×the j-th column is multiplied by the decision variable of the i′-th row×the j′-th column, and the constraint score (U_{ij,i′j′}) of the row representing the set of (i,j) and the column representing the set of (i′,j′) in the constraint score matrix (U), as shown in Expression (10).

$${C}_{U} \cdot {\sum }_{i , j , {i}^{′} , {j}^{′}} {U}_{ij , {i}^{′} , {j}^{′}} {x}_{ij} {x}_{{i}^{′} , {j}^{′}} \qquad ( 10 )$$

C_{U} in Expression (10) is a predetermined constant.

In a case where i=i′, the constraint score (U_{ij,i′j′}) of the row representing the set of (i,j) and the column representing the set of (i′,j′) represents a value indicating that it can be established in a case where j=j′, and represents a value indicating that it cannot be established in a case where j≠j′. In addition, in a case where i≠i′, the constraint score (U_{ij,i′j′}) represents a value indicating that it cannot be established in a case where j=j′, and represents a value indicating that it can be established in a case where j≠j′.

Therefore, in a case where the matching problem is a combination optimization problem that maximizes the objective function (H(x)), Expression (10) has a maximum value in a case where a value is substituted so that the number of second feature points corresponding to the N first feature points is zero or one and the number of first feature points corresponding to the M second feature points is zero or one. In a case where the matching problem is a combination optimization problem that minimizes the objective function (H(x)), Expression (10) has a minimum value in a case where a value is substituted so that the number of second feature points corresponding to the N first feature points is zero or one and the number of first feature points corresponding to the M second feature points is zero or one.

Note that the objective function (H(x)) may have a configuration that does not include any one or two of Expressions (7), (8), and (9). In a case where the objective function (H(x)) does not include Expression (7), the problem generation unit 66 does not include the feature amount score generation unit 80. In a case where the objective function (H(x)) does not include Expression (8), the problem generation unit 66 does not include the position score generation unit 82. In a case where the objective function (H(x)) does not include Expression (9), the problem generation unit 66 does not include the co-occurrence score generation unit 84.

The matching problem generation unit 90 acquires the objective function (H(x)) expressed in Expression (6) generated by the objective function generation unit 88. Then, the matching problem generation unit 90 generates an optimization problem that maximizes the objective function (H(x)) as expressed in Expression (11) or an optimization problem that minimizes the objective function (H(x) as expressed in Expression (12), and provides the optimization problem to the solving unit 68.

$$x = arg max ( {H}_{( x )} ) \qquad ( 11 )$$

$$x = arg min ( {H}_{( x )} ) \qquad ( 12 )$$

As described above, based on the N first feature points detected from the first image and the M second feature points detected from the second image, the self-position estimation device 20 generates a matching problem that is a combination optimization problem that associates any second feature point estimated to represent the same object among the M second feature points with each of the N first feature points. Then, based on the solution to the generated matching problem, the self-position estimation device 20 generates a corresponding point list representing corresponding point pairs including any first feature point of the N first feature points and any associated second feature point of the M second feature points. As a result, according to the self-position estimation device 20, the first feature point included in the first image and the second feature point included in the second image can be accurately associated with each other by simple processing.

### First Modification

Next, a moving body control system 10 according to the first modification will be described.

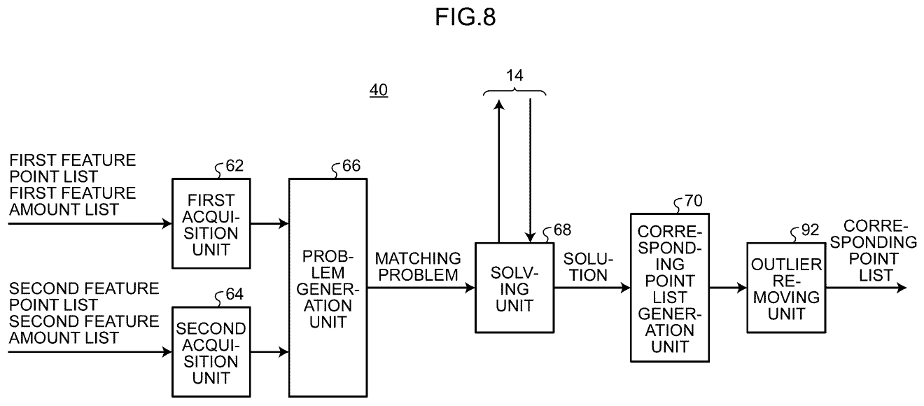

FIG. 8 is a diagram illustrating a functional configuration of the matching unit 40 according to a first modification. The matching unit 40 according to the first modification further includes an outlier removing unit 92.

The outlier removing unit 92 acquires the corresponding point list from the corresponding point list generation unit 70. The outlier removing unit 92 removes a corresponding point pair that is an outlier from among one or a plurality of corresponding point pairs represented by the acquired corresponding point list. Then, the outlier removing unit 92 provides the corresponding point list from which the corresponding point pair serving as the outlier has been removed to the estimation unit 42.

The outlier removing unit 92 identifies a corresponding point pair that is an outlier based on the score of each of one or a plurality of corresponding point pairs included in the corresponding point list, and removes a target point pair that is an outlier identified from the corresponding point list.

For example, the outlier removing unit 92 may identify a corresponding point pair whose score is lower than a preset threshold value as a corresponding point pair that is an outlier. Furthermore, for example, the outlier removing unit 92 may select a predetermined number or a predetermined percentage, which is set in advance, of top corresponding point pairs in terms of score, and may identify a corresponding point pair excluding the predetermined number of or the percentage of selected top corresponding point pairs as a corresponding point pair to be outliers.

The score may be any feature amount of the first feature point and the second feature point included in the corresponding point pair, or a feature amount score that is an average value of the feature amounts. In addition, the score may be a parameter at the time of detecting any feature point of the first feature point and the second feature point included in the corresponding point pair, or a feature point score that is an average value of the parameters. Furthermore, the score may be a value obtained by combining the feature amount score and the feature point score by a predetermined operation.

In addition, the outlier removing unit 92 may identify a corresponding point pair that does not match by the cross-check process as a corresponding point pair that is an outlier. As the cross-check process, the outlier removing unit 92 checks whether the first feature point included in the target corresponding point pair is included in a corresponding point pair other than the target corresponding point pair or whether the second feature point included in the target corresponding point pair is included in a corresponding point pair other than the target corresponding point pair. In a case where the first feature point is included in a corresponding point pair other than the target corresponding point pair or the second feature point is included in a corresponding point pair other than the target corresponding point pair, the outlier removing unit 92 identifies the target corresponding point pair as a corresponding point pair to be an outlier.

The moving body control system 10 according to the first modification can accurately execute the corresponding point association processing based on the first feature point and the second feature point that are accurately selected by removing the corresponding point pair that is the outlier from the corresponding point list by the outlier removing unit 92.

### Second Modification

Next, a moving body control system 10 according to the second modification will be described.

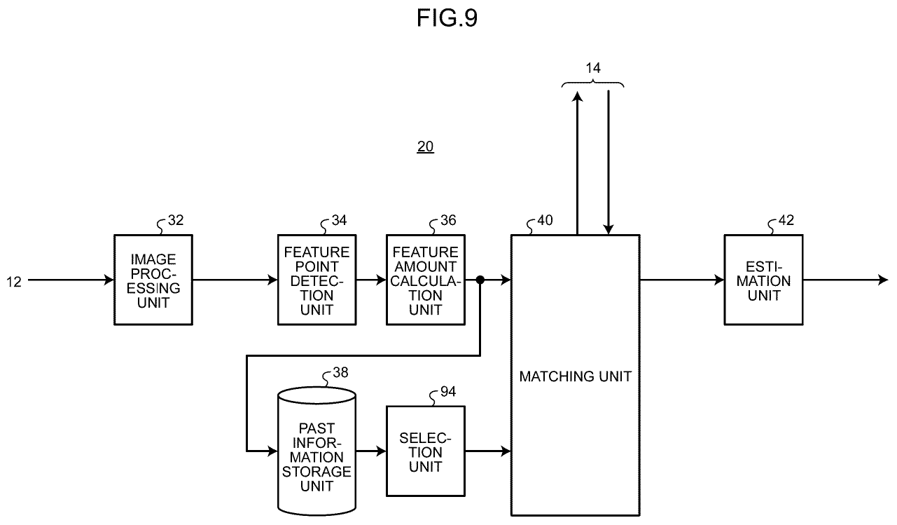

FIG. 9 is a diagram illustrating a functional configuration of a self-position estimation device 20 according to the second modification.

The self-position estimation device 20 according to the second modification further includes a selection unit 94.

In the present modification, it is assumed that L second feature points (L is an integer greater than or equal to M) are detected as one or a plurality of feature points in the second image.

The selection unit 94 acquires the second feature point list and the second feature amount list detected and calculated from the second image from the past information storage unit 38.

The second feature point list indicates L second feature points detected from the second image. The second feature amount list indicates L second feature amounts calculated from the second image. The L second feature amounts correspond to the L second feature points on a one-to-one basis. Each of the L second feature amounts represents a feature amount of a corresponding second feature point among the L second feature points.

The selection unit 94 selects a predetermined number (M) of feature points from among the L second feature points. For example, the selection unit 94 may select M second feature points from the greatest in feature amount among the L second feature points. Furthermore, for example, the selection unit 94 may select M high-order second feature points from the greatest in feature point score, which is a parameter at the time of feature point detection, among the L second feature points. Note that the selection unit 94 may select M second feature points from the L second feature points using another algorithm. Furthermore, for example, the selection unit 94 may select M second feature points based on one or a plurality of specific first feature points among the N first feature points. For example, the selection unit 94 may select M second feature points close in position to a specific first feature point among the N first feature points. For example, the selection unit 94 may select M second feature points having a feature amount similar to that of the specific first feature points.

The selection unit 94 generates a second feature point list indicating M second feature points for the selected M feature points. In addition, the selection unit 94 generates a second feature amount list indicating M second feature amounts for the selected M feature points. In addition, in a case where the L second feature points and the L second feature amounts have a common identifier, the selection unit 94 may generate M identifier lists instead of the selected M feature point lists and M feature amount lists. The selection unit 94 provides the matching unit 40 with a second feature point list indicating M second feature points for the selected M feature points and a second feature amount list indicating M second feature amounts for the selected M feature points.

Then, the matching unit 40 generates a matching problem based on the N first feature points and the N feature amounts detected from the first image and the selected M second feature points and M second feature amounts, and generates a corresponding point list based on a solution to the matching problem.

The solver device 14 is realized by, for example, a hardware Ising machine. The Ising machine can quickly solve a combination optimization problem, but the upper limit of the number of spin variables that can be handled is limited by hardware. Therefore, in a case where the solver device 14 is a hardware Ising machine, the number of the plurality of decision variables included in the matching problem depends on the upper limit of the number of spin variables that can be handled by the Ising machine.

For example, in a case where the number of feature points included in each of the first image and the second image is 1000, the number of the plurality of decision variables included in the matching problem is 1000×1000=1 million. In this case, the number of spin variables handled by the Ising machine is 1 million. However, it is difficult for an Ising machine realized by hardware to solve the Ising problem of 1 million spin variables. Therefore, in a case where the solver device 14 is realized by a hardware Ising machine, the self-position estimation device 20 is required to limit the number of the plurality of decision variables included in the matching problem.

Since the selection unit 94 limits the number of second feature points to M, the self-position estimation device 20 according to the present modification can limit the number of the plurality of decision variables included in the matching problem. As a result, the self-position estimation device 20 can efficiently solve the matching problem using the solver device 14 realized by an Ising machine having a small number of spin variables that can be handled. Note that the self-position estimation device 20 according to the second modification may be applied to the first modification.

Note that the selection unit 94 may appropriately change the number of second feature points to be selected from among the L second feature points. That is, the selection unit 94 may appropriately change M. For example, in a case where a larger feature amount is better, the selection unit 94 may select a second feature point having a second feature amount greater than or equal to a preset threshold value. Furthermore, for example, in a case where a smaller feature amount is better, the selection unit 94 may select a second feature point having a second feature amount less than or equal to a preset threshold value.

In a case where the distance from the specific position is preferably small, the selection unit 94 may select M second feature points having a small distance from the specific position from among the L second feature points. For example, the selection unit 94 may select, from among the L second feature points, M second feature points from the closest in distance from a specific position, the distance from the specific position being less than or equal to a threshold value and/or the feature amount being less than or equal to a threshold value. Further, for example, the selection unit 94 may select two or more second feature points whose distance from a specific position is less than or equal to a threshold value and/or whose feature amount is less than or equal to a threshold value from the L second feature points, and may select M second feature points from the greatest in feature amount from the selected two or more second feature points.

In addition, instead of acquiring the second feature point list and the second feature amount list, the selection unit 94 may acquire the first feature point list and the first feature amount list detected and calculated from the first image. In this case, the first feature point list indicates K first feature points detected from the first image (K is an integer greater than or equal to N). In addition, the first feature amount list indicates K first feature amounts calculated from the first image. The K first feature amounts correspond to the K first feature points on a one-to-one basis. Each of the K first feature amounts represents a feature amount of a corresponding first feature point among the K first feature points. In such a case, the selection unit 94 selects a predetermined number of N feature points from among the K first feature points. For example, the selection unit 94 may select N first feature points based on one or a plurality of specific second feature points among the M second feature points. For example, the selection unit 94 may select N first feature points close in position to a specific second feature point among the M second feature points. For example, the selection unit 94 may select N first feature points having a feature amount similar to that the specific second feature points.

In such a case, the selection unit 94 generates a first feature point list indicating N first feature points for the selected N feature points. In addition, the selection unit 94 generates a first feature amount list indicating N first feature amounts for the selected N feature points. The selection unit 94 provides the matching unit 40 with a first feature point list indicating N first feature points for the selected N feature points and a first feature amount list indicating N first feature amounts for the selected N feature points. Even with such a configuration, in the self-position estimation device 20 according to the present modification, since the number of first feature points is limited to N by the selection unit 94, the number of decision variables included in the matching problem can be limited.

In addition, also in the case of acquiring the first feature point list and the first feature amount list detected and calculated from the first image, the selection unit 94 may appropriately change the number of first feature points to be selected from the K first feature points. That is, the selection unit 94 may appropriately change N. For example, in a case where a larger feature amount is better, the selection unit 94 may select a first feature point having a first feature amount greater than or equal to a preset threshold value. Furthermore, for example, in a case where a smaller feature amount is better, the selection unit 94 may select a first feature point having a first feature amount less than or equal to a preset threshold value.

In a case where the distance from the specific position is preferably small, the selection unit 94 may select N first feature points having a small distance from the specific position from among the K first feature points. For example, the selection unit 94 may select, from among the K first feature points, N first feature points from the closest in distance from a specific position, the distance from the specific position being less than or equal to a threshold value and/or the feature amount being less than or equal to a threshold value. Furthermore, for example, the selection unit 94 may select, from among the K first feature points, two or more first feature points whose distances from a specific position are less than or equal to a threshold value and/or whose feature amounts are less than or equal to a threshold value, and select, from among the two or more selected first feature points, N first feature points from the greatest in feature amount.

In addition, the selection unit 94 may acquire the first feature point list and the first feature amount list detected and calculated from the first image, and may acquire the second feature point list and the second feature amount list detected and calculated from the second image. Then, in this case, the selection unit 94 simultaneously executes processing of selecting N first feature points from among the K first feature points to generate a first feature point list and a first feature amount list, and processing of selecting M first feature points from among the L second feature points to generate a second feature point list and a second feature amount list.

### Third Modification

Next, the moving body control system 10 according to the third modification will be described.

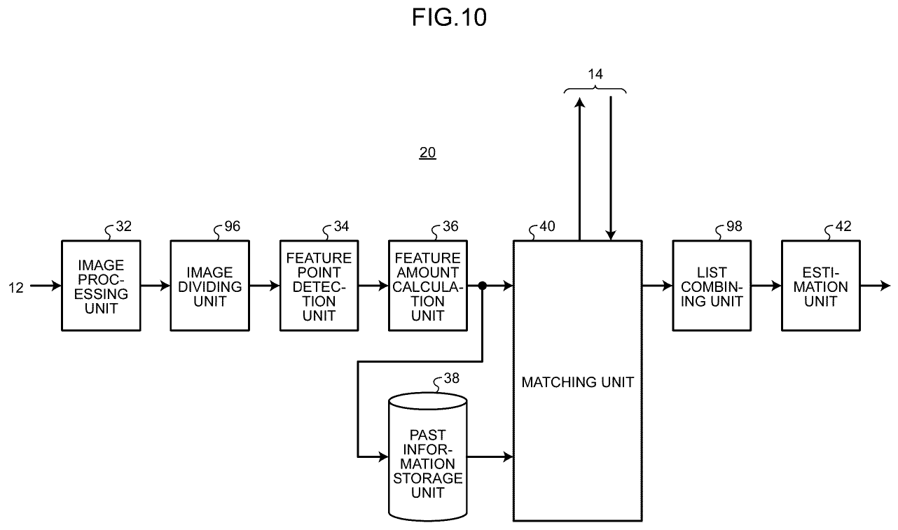

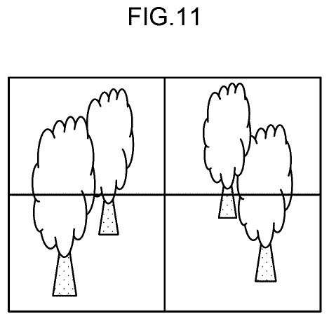

FIG. 10 is a diagram illustrating a functional configuration of a self-position estimation device 20 according to a third modification. FIG. 11 is a diagram illustrating a plurality of partial images obtained by dividing the input image.

The self-position estimation device 20 according to the third modification further includes an image dividing unit 96 and a list combining unit 98.

The image dividing unit 96 acquires input images at predetermined time intervals when the image processing unit 32 performs an image process. The image dividing unit 96 divides each of the input images at predetermined time intervals into a plurality of partial images corresponding to a plurality of predetermined partial regions.

For example, the image dividing unit 96 generates four partial images by dividing the input image into two in the vertical direction and two in the horizontal direction as illustrated in FIG. 11. Note that the image dividing unit 96 may divide the input image into any regions as long as the region is divided at the preset position.

The feature point detection unit 34 detects one or a plurality of feature points for each of the plurality of partial images for each input image at predetermined time intervals. Then, the feature point detection unit 34 generates a feature point list for each of the plurality of partial images for each input image at predetermined time intervals.

The feature amount calculation unit 36 calculates one or a plurality of feature amounts corresponding to one or a plurality of detected feature points for each of a plurality of partial images for each input image at predetermined time intervals. Then, the feature amount calculation unit 36 generates a feature amount list for each of the plurality of partial images for each input image at predetermined time intervals.

Note that the image dividing unit 96 may be provided after the feature amount calculation unit 36. In this case, the feature point detection unit 34 detects the feature point from the input image before the division. Furthermore, the feature amount calculation unit 36 calculates a feature amount based on the input image before division. Then, in this case, the image dividing unit 96 determines in which region of the plurality of regions each of the one or the plurality of feature points detected by the feature point detection unit 34 is included, and divides the one or the plurality of feature points for each of the plurality of regions. Furthermore, the image dividing unit 96 divides one or a plurality of feature amounts calculated by the feature amount calculation unit 36 in association with one or a plurality of feature points. Then, the image dividing unit 96 generates a feature point list and a feature amount list for each of the plurality of regions.

The past information storage unit 38 stores a feature point list and a feature amount list for each of the plurality of partial images in the past input image.

The matching unit 40 generates a corresponding point list for each of the plurality of partial images for each input image at predetermined time intervals.

In the present modification, an input image to be processed is set as a first input image. The input image before the first input image is set as the second input image. The second input image is, for example, an input image immediately before the first input image. Further, for example, the second input image may be a key frame image before the first input image.

Furthermore, in the present modification, the first image to be processed by the matching unit 40 is any one first partial image of the plurality of partial images obtained by dividing the first input image. The second image is a second partial image in a region same as a region of the first partial image among the plurality of partial images obtained by dividing the second input image.

In the present modification, the matching unit 40 acquires a first feature point list indicating N first feature points detected from a first image (that is, the first partial image among the plurality of partial images obtained by dividing the first input image) and a first feature amount list indicating N first feature amounts calculated from the first image.

In addition, the matching unit 40 acquires, from the past information storage unit 38, a second feature point list indicating M second feature points detected from the second image (that is, the second partial image of a region same as a region of the first partial image among the plurality of partial images obtained by dividing the second input image) and a second feature amount list indicating M second feature amounts calculated from the second image.

Then, the matching unit 40 provides the corresponding point list generated for each of the plurality of partial images to the list combining unit 98 for each input image at predetermined time intervals.

The list combining unit 98 generates, for each input image at predetermined time intervals, a composite corresponding point list obtained by composite corresponding point lists generated for a plurality of respective partial images obtained by dividing the first input image. Then, the list combining unit 98 provides the generated composite corresponding point list to the estimation unit 42.

In the present modification, the estimation unit 42 acquires a composite corresponding point list for each input image at predetermined time intervals. Then, the estimation unit 42 estimates the self-position, which is the position of the camera 12 in the three-dimensional space, based on the acquired composite corresponding point list at predetermined time intervals.

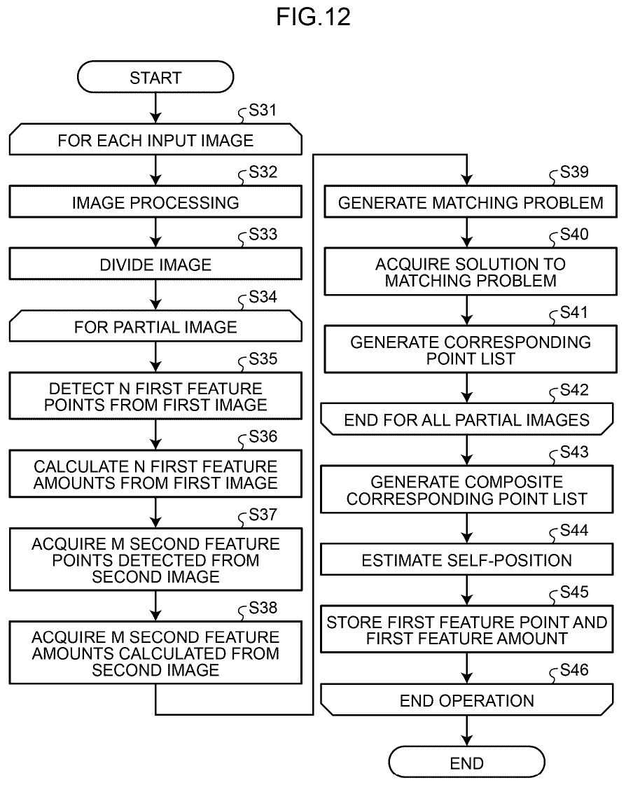

FIG. 12 is a flowchart illustrating a flow of processing of the self-position estimation device 20 according to the third modification. The self-position estimation device 20 according to the third modification executes processing in the flow illustrated in FIG. 12.

The self-position estimation device 20 acquires an input image from the camera 12 at predetermined time intervals. Every time the input image is acquired, the self-position estimation device 20 executes processing from S32 to S45 with the acquired input image as the first input image (loop processing between S31 and S46).

First, in S32, the self-position estimation device 20 performs an image process on the first input image.

Subsequently, in S33, the self-position estimation device 20 divides the first input image into a plurality of partial images corresponding to a plurality of predetermined partial regions.

Subsequently, the self-position estimation device 20 executes processing from S35 to S41 for each of the plurality of partial images obtained by dividing the first input image (loop processing between S34 and S41). Note that the self-position estimation device 20 executes processing with the partial image to be processed from S35 to S41 as the first image.

In S35, the self-position estimation device 20 detects N first feature points from the first image.

Subsequently, in S36, the self-position estimation device 20 calculates N first feature amounts from the first image.

Subsequently, in S37, the self-position estimation device 20 acquires M second feature points detected from the second image.

Subsequently, in S38, the self-position estimation device 20 acquires M second feature amounts calculated from the second image.

Subsequently, in S39, the self-position estimation device 20 generates a matching problem based on the N first feature points and the N first feature amounts, and the M second feature points and the M second feature amounts.

Subsequently, in S40, the self-position estimation device 20 acquires a solution to the matching problem.

Subsequently, in S41, the self-position estimation device 20 generates a corresponding point list representing corresponding point pairs based on the solution to the matching problem.

Then, in S42, in a case where the processing from S35 to S41 is ended for all of the plurality of partial images obtained by dividing the first input image, the self-position estimation device 20 advances the process to S43.

In S43, the self-position estimation device 20 generates a composite corresponding point list obtained by composite corresponding point lists generated for the plurality of respective partial images obtained by dividing the first input image.

Subsequently, in S44, the self-position estimation device 20 estimates the self-position, which is the location of the camera 12 that has captured the first input image, in the three-dimensional space based on the composite corresponding point list.

Subsequently, in S45, the self-position estimation device 20 stores the N first feature points and the N first feature amounts detected from each of the plurality of divided images obtained by dividing the first input image as the M second feature points and the M second feature amounts detected from each of the plurality of divided images obtained by dividing the second input image. As a result, the self-position estimation device 20 can acquire the M second feature points and the M second feature amounts in the process on the next first input image.

Note that, in a case where the second input image is a key frame image designated before the first input image, the self-position estimation device 20 does not execute the processing of S45 if the first input image is not a key frame image.

The self-position estimation device 20 repeats the processing from S32 to S45 for each input image until the operation of the moving body ends (S46). Then, in a case where the operation of the moving body is ended, the self-position estimation device 20 ends this flow.

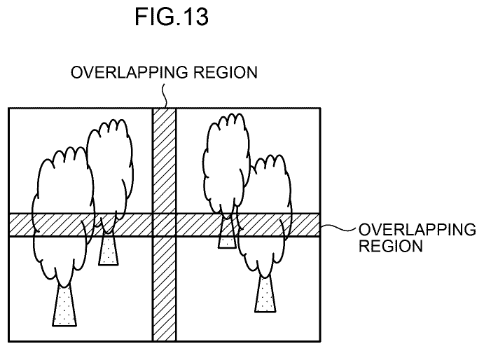

FIG. 13 is a diagram illustrating a plurality of partial images obtained by dividing the input image in a case where the partial images partially overlap.

The image dividing unit 96 divides the input image into a plurality of partial images corresponding to a plurality of predetermined partial regions. In this case, the first region and the second region adjacent to each other among the plurality of predetermined regions may partially overlap as illustrated in FIG. 13.

In this case, the list combining unit 98 determines whether two or more corresponding point pairs in which at least one of the first feature point or the second feature point overlaps are included in the composite corresponding point list. Then, the list combining unit 98 deletes some of two or more corresponding point pairs in which at least one of the first feature point or the second feature point overlaps so that two or more corresponding point pairs in which at least one of the first feature point or the second feature point overlaps are not included.

For example, the list combining unit 98 may delete all of two or more corresponding point pairs in which at least one of the first feature point or the second feature point overlaps from the composite corresponding point list. Furthermore, for example, the list combining unit 98 may leave a corresponding point pair having the largest feature amount score or a corresponding point pair having the largest feature point score among two or more corresponding point pairs in which at least one of the first feature point or the second feature point overlaps, and delete the other corresponding point pairs.

Furthermore, for example, the list combining unit 98 may cause the matching unit 40 to generate a new corresponding point list as follows.

In a case where the matching unit 40 is caused to generate a new corresponding point list, the list combining unit 98 identifies a new partial region including two or more corresponding point pairs in which at least one of the first feature point or the second feature point overlaps. The new partial region is a partial region in the input image.

Subsequently, the list combining unit 98 provides information indicating the position of the new partial region to the matching unit 40. The matching unit 40 acquires a plurality of first feature points and a plurality of first feature amounts detected and calculated from a new partial region in the first input image. In addition, the matching unit 40 acquires a plurality of second feature points and a plurality of second feature amounts detected and calculated from a new partial region in the second input image.

Subsequently, the matching unit 40 generates a matching problem again based on the plurality of acquired first feature points and the plurality of acquired first feature amounts and the plurality of acquired second feature points and the plurality of acquired second feature amounts. Subsequently, the matching unit 40 generates a new corresponding point list representing one or more new corresponding point pairs in which any first feature point of the plurality of first feature points is associated with any second feature point of the plurality of second feature points based on the solution to the matching problem generated again.

Then, the list combining unit 98 replaces two or more corresponding point pairs in which at least one of the first feature point or the second feature point included in the composite corresponding point list overlaps with one or more new corresponding point pairs included in the new corresponding point list, and updates the composite corresponding point list.

Two feature points at distant positions on the image are less likely to affect the simultaneous feasibility of the pair. Therefore, even when the matching processing is separately performed on two feature points at distant positions on the image, there is little possibility of affecting the result.

However, two feature points in the vicinity positioned with the division boundary interposed therebetween may affect the co-occurrence score. However, in a case where the matching processing is separately performed on two feature points in the vicinity positioned with the division boundary interposed therebetween, the mutual relationship is not reflected in the co-occurrence score. Therefore, by generating a plurality of partially overlapped partial images, the self-position estimation device 20 according to the present modification can reflect the two feature points in the vicinity positioned with the division boundary interposed therebetween in the co-occurrence score.

However, by generating a plurality of partially overlapped partial images, the composite corresponding pair may include two or more corresponding point pairs in which at least one of the first feature point or the second feature point overlaps. However, since the list combining unit 98 performs the above-described deletion processing or generates a new corresponding point list, it is possible to generate a composite corresponding point list that does not include two or more corresponding point pairs in which at least one of the first feature point or the second feature point overlaps. Note that the list combining unit 98 may generate a composite corresponding point list by another method so as not to include two or more corresponding point pairs in which at least one of the first feature point or the second feature point overlaps instead of performing the above-described deletion processing or generating a new corresponding point list.

As described above, the self-position estimation device 20 according to the present modification divides the input image into a plurality of partial images, and generates a matching problem for each of the plurality of partial images. As a result, the self-position estimation device 20 according to the present modification can reduce the number of the plurality of decision variables included in the matching problem. Therefore, the self-position estimation device 20 can efficiently solve the matching problem using the solver device 14 realized by an Ising machine having a small number of spin variables that can be handled.

Note that the self-position estimation device 20 according to the third modification may be applied to the second modification. As a result, the self-position estimation device 20 according to the present modification can further reduce the number of the plurality of decision variables included in the matching problem.

### Fourth Modification

Next, a moving body control system 10 according to the fourth modification will be described.

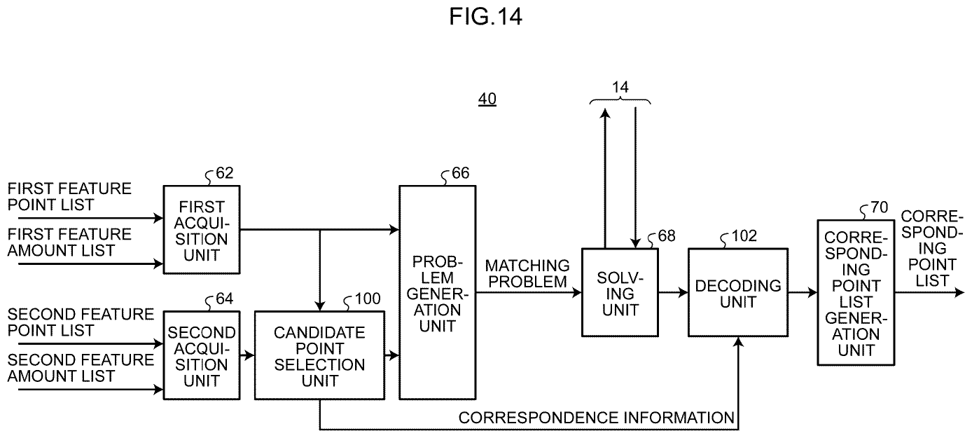

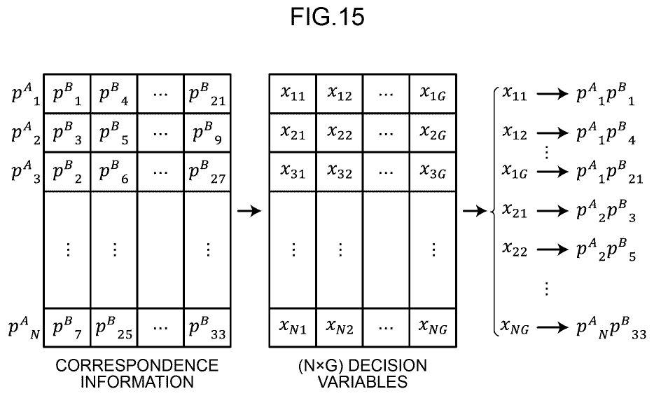

FIG. 14 is a diagram illustrating a functional configuration of a matching unit 40 according to the fourth modification. FIG. 15 is a diagram for describing the content of selection processing and decoding processing of the candidate point in the fourth modification.

The matching unit 40 according to the fourth modification further includes a candidate point selection unit 100 and a decoding unit 102.

The candidate point selection unit 100 acquires the first feature point list and the first feature amount list from the first acquisition unit 62. The candidate point selection unit 100 also acquires the second feature point list and the second feature amount list from the second acquisition unit 64.

The candidate point selection unit 100 selects, for each of the N first feature points represented in the first feature point list, G candidate points (G is an integer greater than or equal to one and less than M,) among the M second feature points represented in the second feature point list. In this case, the candidate point selection unit 100 may select G candidate points of different combinations for each of the N first feature points. For example, the candidate point selection unit 100 may select, for each of the N first feature points, G second feature points in ascending order of the difference in feature amount between the first feature point and the second feature point. For example, the candidate point selection unit 100 may select, for each of the N first feature points, G second feature points in ascending order of the distance to the first feature point. For example, the candidate point selection unit 100 may select, from among the M first feature points, G first feature points from the greatest in feature amount, the distances from a specific position being less than or equal to a threshold value and the feature amount being less than or equal to a threshold value. Further, for example, the candidate point selection unit 100 may select, from among the M first feature points, two or more first feature points whose distances from a specific position are less than or equal to a threshold value and whose feature amounts are less than or equal to a threshold value, and select, from among the two or more selected first feature points, G first feature points from the closest in distance from specific position are close.

Further, the candidate point selection unit 100 generates the correspondence information. The correspondence information represents G candidate points selected for each of the N first feature points. For example, FIG. 15 illustrates correspondence information represented by a matrix of N rows and G columns. For example, in the example of FIG. 15, the candidate point selection unit 100 selects p^{B}₁, p^{B}₄, . . . , and p^{B}₂₁ as the G candidate points for p^{A1} that is one of the first feature points. The candidate point selection unit 100 selects p^{B}₃, p^{B}₅, . . . , and p^{B}₉ as the G candidate points for p^{A}₂ that is one of the first feature points. The candidate point selection unit 100 selects p^{B}₂, p^{B}₆, . . . , P^{B}₂₇ as the G candidate points for p^{A}₃ that is one of the first feature points. The candidate point selection unit 100 selects p^{B}₇, p^{B}₂₅, . . . , and p^{B}₃₃ as the G candidate points for p^{A}_{N} that is one of the first feature points.

The candidate point selection unit 100 provides the first feature point list, the second feature amount list, and the correspondence information to the problem generation unit 66. The candidate point selection unit 100 also provides the decoding unit 102 with the correspondence information.

The problem generation unit 66 generates a matching problem. In the present modification, the matching problem is a combination optimization problem that associates any candidate point estimated to represent the same object among the G candidate points selected for the corresponding first feature point with each of the N first feature points. In the present modification, the objective function of the matching problem includes (N×G) decision variables. Then, the objective function is minimized or maximized in a case where all of the (N×G) decision variables are set to correct answer values.

For example, in a case where (N×G) decision variables are disposed in N rows and G columns, the value of the decision variable of the i-th row×the j-th column among the (N×G) decision variables indicates whether the i-th first feature point among the N first feature points and the j-th candidate point among the G candidate points selected for the i-th first feature point are a corresponding point pair. Then, in a case where the i-th first feature point and the j-th candidate point selected for the i-th first feature point are the same object, the correct answer value in the decision variable of the i-th row×the j-th column is a value (for example, −1) indicating that it is a corresponding point pair. Furthermore, in a case where the i-th first feature point and the j-th candidate point selected for the i-th first feature point are not the same object, the correct answer value in the decision variable of the i-th row×the j-th column is a value (for example, +1) indicating that it is not a corresponding point pair.

For example, in the example of FIG. 15, x₁₁ which is a decision variable disposed in the first row and the first column indicates whether p^{A}₁ and p^{B}₁ are a corresponding point pair. Further, x₁₂ which is a decision variable disposed in the first row and the second column indicates whether p^{A}₁ and p^{B}₄ are a corresponding point pair. In addition, x_{1G} which is a decision variable disposed in the first row and the G-th column indicates whether p^{A}₁ and p^{B}₂₁ are a corresponding point pair. In addition, x₂₁ which is a decision variable disposed in the second row and the first column indicates whether p^{A}₂ and p^{B}₃ are a corresponding point pair. In addition, x₂₂ which is a decision variable disposed in the second row and the second column indicates whether p^{A}₂ and p^{B}₅ are a corresponding point pair. Then, x_{NG} which is a decision variable disposed in the N-th row and the G-th column indicates whether the P^{A}_{N} and the p^{B}₃₃ are a corresponding point pair.

Then, the problem generation unit 66 provides the generated matching problem to the solving unit 68.

The solving unit 68 provides the matching problem thus acquired to the solver device 14 to acquire a solution to the matching problem from the solver device 14. Note that, in a case where the matching problem can be easily solved, the matching unit 40 may solve the matching problem by itself without providing the matching problem to the solver device 14. The solving unit 68 provides a solution to the matching problem to the decoding unit 102.

The decoding unit 102 converts a solution to a matching problem that minimizes or maximizes an objective function including (N×G) decision variables into a solution representing that each of the N first feature points is associated with which second feature point of the M second feature points based on the correspondence information. Then, the decoding unit 102 provides the solution to the generated matching problem to the corresponding point list generation unit 70.

The self-position estimation device 20 according to the present modification can associate each of the N first feature points with any second feature point among the M second feature points based on the solution to the matching problem in which the number of the plurality of decision variables is reduced. As a result, the self-position estimation device 20 can efficiently solve the matching problem using the solver device 14 realized by an Ising machine having a small number of spin variables that can be handled. Note that the self-position estimation device 20 according to the fourth modification may be applied to the first modification and the second modification.

In the fourth modification, the candidate point selection unit 100 may select, for each of the M second feature points represented in the second feature point list, Z candidate points (Z is an integer greater than or equal to one and less than N) among the N first feature points represented in the first feature point list. In this case, the candidate point selection unit 100 may select Z candidate points of different combinations for each of the M second feature points.

In this case, the correspondence information represents Z candidate points selected for each of the M second feature points. The matching problem is a combination optimization problem that associates any candidate point estimated to represent the same object among the Z candidate points selected for the corresponding second feature point with each of the M second feature points. The objective function of the matching problem includes (M×Z) decision variables. Then, the objective function is minimized or maximized in a case where all of the (M×Z) decision variables are set to correct answer values.

For example, in a case where (M×Z) decision variables are disposed in M rows and Z columns, the value of the decision variable of the i-th row×the j-th column among the (M×Z) decision variables indicates whether the i-th second feature point among the M second feature points and the j-th candidate point among the Z candidate points selected for the i-th second feature point are a corresponding point pair. Then, in a case where the i-th second feature point and the j-th candidate point selected for the i-th second feature point are the same object, the correct answer value in the decision variable of the i-th row×the j-th column is a value (for example, −1) indicating that it is a corresponding point pair. In addition, in a case where the i-th second feature point and the j-th candidate point selected for the i-th second feature point are not the same object, the correct answer value in the decision variable of the i-th row×the j-th column is a value (for example, +1) indicating that it is not a corresponding point pair.

Even with such a configuration, the self-position estimation device 20 can efficiently solve the matching problem using the solver device 14 realized by an Ising machine with a small number of spin variables that can be handled.

### Solver Device 14

Next, the solver device 14 that solves the combination optimization problem will be described.

The combination optimization problem is a problem that solves a combination of values of a plurality of decision variables that minimizes or maximizes an objective function. The objective function includes a plurality of decision variables representing the state of the system to be optimized as arguments, and is a linear or higher-dimensional function of the plurality of decision variables. For example, the objective function is represented by a polynomial that sums a plurality of terms. Each of the terms is a function that multiplies one or more and a predetermined number or less decision variables by a coefficient. The coefficient in each of the plurality of terms is a real number and is also referred to as a weight value. In this case, each of the plurality of terms constituting the objective function is represented by multiplication of one or more decision variables among the plurality of decision variables and any one weight value among the plurality of weight values. The objective function may include a term represented by a function such as an exponential function or a logarithmic function.

Each of the plurality of decision variables may be a discrete value or a continuous value. In addition, the discrete value may represent zero or one, or may be an Ising spin representing −1 or +1. In addition, some of the plurality of decision variables included in the objective function may be discrete values, and some of the other decision variables may be continuous values.

The state of the system expressed by the plurality of decision variables is referred to as a solution. A whole set of a plurality of solutions that is allowed to be taken by a state of a system is referred to as a solution space. In the problem of minimizing the objective function, a solution that minimizes the function value of the objective function is referred to as an exact solution. In the problem of minimizing the objective function, a solution in which the function value of the objective function is a value close to the minimum value is referred to as a good solution.

In addition, the combination optimization problem may include a constraint condition. The constraint condition represents a condition to be satisfied by the solution. The constraint condition is one or a plurality of constraint expressions expressed using some of the plurality of decision variables included in the objective function. The constraint expression may be an equality or an inequality.

The QUBO problem is an unconstrained quadratic optimization problem in which the decision variable is a binary value. In the QUBO problem, each of a plurality of terms included in the objective function is expressed by a linear expression or a quadratic expression of the decision variable.

The objective function of the QUBO problem is expressed by H_{total_QUBO} of Expression (13).

$${H}_{total \_ QUBO} = {\sum }_{i = 1}^{N} {\sum }_{j = 1}^{N} {Q}_{ij} {b}_{i} {b}_{j} = 2 {\sum }_{i = 1}^{N} {\sum }_{i < j}^{N} {Q}_{ij} {b}_{i} {b}_{j} + {\sum }_{i = 1}^{N} {Q}_{ii} {b}_{i} \qquad ( 13 )$$

In Expression (13), N is an integer of two or more and represents the number of decision variables. In Expression (13), i and j represent any integer greater than or equal to one and less than or equal to N. bᵢ is zero or one, and represents the i-th decision variable among the N decision variables. bⱼ is zero or one, and represents the j-th decision variable among the N decision variables. Qᵢⱼ represents coefficients of the i-th row and the j-th column included in the coefficient matrix (Q) of N×N. Note that Qᵢⱼ=Qⱼᵢ. Qᵢᵢ is a coefficient included of the i-th row and the i-th column of the coefficient matrix (Q), and is a coefficient multiplied by the first-order term of the i-th decision variable. Qᵢᵢ is referred to as a bias coefficient.

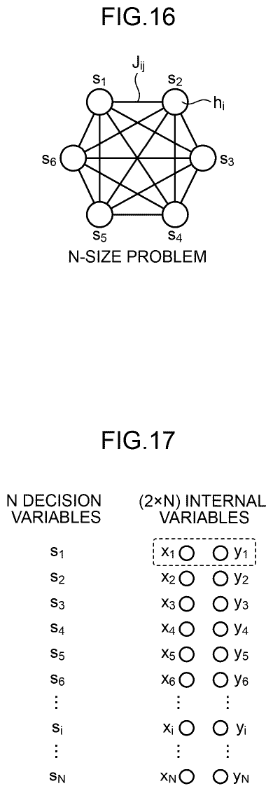

FIG. 16 is a diagram illustrating a model of an Ising problem. The Ising problem is a problem of searching a ground state of an Ising model. The Ising problem is one of the QUBO problems. The decision variable of the Ising problem represents a discrete variable of −1 or +1.

The objective function of the Ising problem is expressed by H_{total_Ising} of Expression (14).

$${H}_{total \_ Ising} = - \frac{1}{2} {\sum }_{i = 1}^{N} {\sum }_{j = 1}^{N} {J}_{ij} {s}_{i} {s}_{j} + {\sum }_{i = 1}^{N} {h}_{i} {s}_{i} \qquad ( 14 )$$

In Expression (14), N is an integer greater than or equal to two and represents the number of decision variables. In Expression (14), i and j represent any integer greater than or equal to one and less than or equal to N. sᵢ is −1 or +1, and represents the i-th decision variable among the N decision variables. sⱼ is −1 or +1, and represents the j-th decision variable among the N decision variables. Jᵢⱼ represents coefficients of the i-th row and the j-th column included in the coefficient matrix (J) of N×N. Note that Jᵢⱼ=Jⱼᵢ. hᵢ is a coefficient multiplied by a first-order term of the i-th decision variable. hᵢ is referred to as a bias coefficient.

The Ising problem corresponds to the problem of the ground state search of the Ising model, which is one of the magnetic body models in the statistical mechanics. Therefore, sᵢ may be referred to as a spin variable. Furthermore, N, which is the number of decision variables, may be referred to as the number of spins. In addition, H_{total_Ising} may be referred to as Ising energy. The vector represented by the N sis having the minimum value of H_{total_Ising} may be referred to as a ground state (ground spin arrangement).

The objective function of the QUBO problem and the objective function of the Ising problem differ only in the value of the constant. Therefore, the QUBO problem and the Ising problem are the same as a combination optimization problem. That is, the QUBO problem and the Ising problem can be mutually converted. For example, the Ising problem and the QUBO problem are mutually converted by Expressions (15-1), (15-2), 15-3), and (15-4).

$${s}_{i} = 2 {b}_{i} - 1 \qquad ( 15 - 1 )$$

$${J}_{ij} = - \frac{{Q}_{ij}}{2} ( i \neq j ) \qquad ( 15 - 2 )$$

$${J}_{ij} = 0 \qquad ( 15 - 3 )$$

$${h}_{i} = {\sum }_{j = 1}^{N} \frac{{Q}_{ij}}{2} \qquad ( 15 - 4 )$$

The QUBO and Ising problems are known to be NP-complete. That is, many NP-hard problems can be converted into a QUBO problem or an Ising problem in polynomial time. Therefore, many practical combination optimization problems can be converted into the QUBO problem or the Ising problem.

The Ising machine is a device that solves an Ising problem. Many Ising machines solve Ising problems with heuristic solutions. Ising machines of various principles based on electronics, optics, quantum mechanics, statistical mechanics, and the like have been proposed. Many Ising machines can output an exact solution or a good solution in a short time.

The simulated bifurcation algorithm is an algorithm for solving a combination optimization problem. The simulated bifurcation algorithm is a heuristic solution algorithm.

For example, “Hayato Goto, Kosuke Tatsumura and Alexander R. Dixon, “Combinatorial optimization by simulating adiabatic bifurcations in nonlinear Hamiltonian systems”, Science Advances 5, eaav2372, 2019” and “Hayato Goto, Kotaro Endo, Masaru Suzuki, Yoshisato Sakai, Taro Kanao, Yohei Hamakawa, Ryo Hidaka, Masaya Yamasaki and Kosuke Tatsumura, “High-performance combinatorial optimization based on classical mechanics”, Science Advances 7, eabe7953, 2021”, and “JP 2021-060864 A”, “JP 2019-145010 A”, “JP 2019-159566 A”, “JP 2021-043667 A”, and “JP 2021-043589 A” disclose the simulated bifurcation algorithm. The simulated bifurcation algorithm is also referred to as a quantum inspired algorithm because it has been discovered with an idea from a quantum mechanical optimization method based on the quantum adiabatic theorem. The simulated bifurcation algorithm can solve a combination optimization problem in which the objective function is a quadratic function of a plurality of decision variables. The simulated bifurcation algorithm can also solve a combination optimization problem in which the objective function is a cubic or higher function of a plurality of decision variables, that is, a higher order binary optimization (HUBO) problem. For example, a simulated bifurcation algorithm that solves the HUBO problem is disclosed in JP 2021-043667 A. Moreover, the simulated bifurcation algorithm can also solve a combination optimization problem including variables of continuous values in some or all of a plurality of decision variables. A simulated bifurcation algorithm that solves a combination optimization problem including variables of continuous values in some or all of a plurality of decision variables is disclosed in JP 2021-043589 AA.

The simulated bifurcation machine is a calculation device that executes a process according to the simulated bifurcation algorithm. A simulated bifurcation machine that solves a QUBO problem or an Ising problem is an example of an Ising machine. In the present embodiment, the simulated bifurcation machine solves the Ising problem.

FIG. 17 is a diagram illustrating internal variables used by the simulated bifurcation algorithm.

In a case of solving a combination optimization problem in which an objective function is represented using N decision variables (s₁ to s_{N}), the simulated bifurcation algorithm uses N position variables (x₁ to x_{N}) and N momentum variables (y₁ to y_{N}) as internal variables. That is, the simulated bifurcation algorithm uses 2×N internal variables.

N position variables (xᵢ) correspond to N decision variables (sᵢ) on a one-to-one basis. That is, the i-th position variable (xᵢ) among the N position variables corresponds to the i-th decision variable (sᵢ) among the N decision variables. N momentum variables (yᵢ) correspond to N decision variables (sᵢ) on a one-to-one basis. That is, the i-th momentum variable (yᵢ) among the N momentum variables corresponds to the i-th decision variable (sᵢ) among the N decision variables.

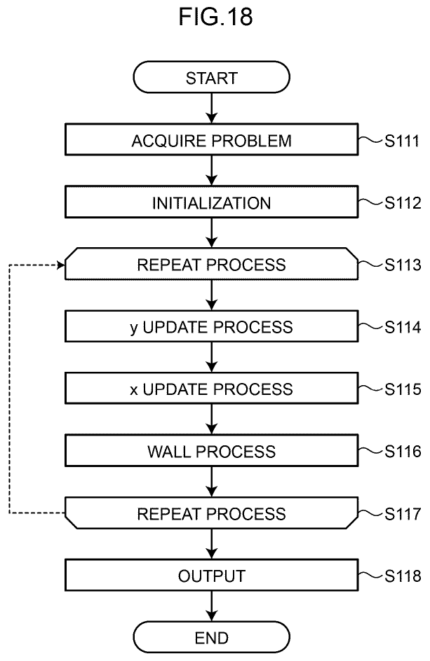

FIG. 18 is a flowchart illustrating a flow of a process of the simulated bifurcation machine. The simulated bifurcation machine executes a process according to the simulated bifurcation algorithm in the flow illustrated in FIG. 18.

First, in S111, the simulated bifurcation machine acquires the Ising problem. Specifically, the simulated bifurcation machine acquires J, which is a matrix including N×N coefficients, and h including N bias coefficients.

Subsequently, in S112, the simulated bifurcation machine initializes 2×N internal variables, that is, N position variables (x₁ to x_{N}) and N momentum variables (y₁ to y_{N}). The simulated bifurcation machine may acquire both or one of the initial values of the N position variables (x₁ to x_{N}) and the initial values of the N momentum variables (y₁ to y_{N}) from the outside. Furthermore, the simulated bifurcation machine may generate the initial values of the N position variables (x₁ to x_{N}) and the initial values of the N momentum variables (y₁ to y_{N}) by a random number generated by a random number generation circuit, or may set the initial values to predetermined values. Note that, since the simulated bifurcation machine is heuristic, even in the same problem, in a case where at least one of the initial values of the N position variables (x₁ to x_{N}) and the initial values of the N momentum variables (y₁ to y_{N}) is different, a different good solution may be output.

Subsequently, the simulated bifurcation machine repeats the process of S114 to S116 a preset number of times (loop processing between S113 and S117). The process of S114 to S116 is a matrix arithmetic process of matrix-multiplying N position variables (x₁ to x_{N}) by a matrix including weight values of N rows×N columns, and a time evolution process of time-evolving the N position variables (x₁ to x_{N}) and the N momentum variables (y₁ to y_{N}).

In S114, the simulated bifurcation machine executes a y update process of updating each of the N momentum variables (y₁ to y_{N}). In the update process of the i-th momentum variable (y₁) in the y update processing, the simulated bifurcation machine updates the i-th momentum variable (y₁) by the N position variables (x₁ to x_{N}), the N coefficients (J_{i,j}) representing the interaction between the i-th position variable (x₁) in the N×N matrices (J) and the other (N−1) position variables (x_{1 to i-1}, x_{i+1 to N}), and the i-th bias coefficient (hᵢ).

Subsequently, in S115, the simulated bifurcation machine executes an x update process of updating each of the N position variables (x₁ to x_{N}). The simulated bifurcation machine updates the i-th position variable (x₁) by the i-th momentum variable (y₁) in the update process of the i-th position variable (x₁) in the x update processing.

Note that the simulated bifurcation machine may execute the process of S114 and the process of S115 in an order changed.

Subsequently, in S116, the simulated bifurcation machine executes a wall process on the position variable whose absolute value exceeds one among the N position variables (x₁ to x_{N}). Furthermore, the simulated bifurcation machine also executes a wall process on the momentum variable corresponding to the position variable whose absolute value exceeds one. For example, in the wall process, the simulated bifurcation machine changes a value of the position variable whose absolute value exceeds one to a value whose absolute value is one or smaller than one in a state where the signs are the same. Moreover, for example, the simulated bifurcation machine changes a value of the momentum variable corresponding to the position variable whose absolute value exceeds one to zero in the wall processing.

The simulated bifurcation algorithm has variations in operations of the x update processing, the y update processing, and the wall processing. For example, variations of the simulated bifurcation algorithm include an adiabatic simulated bifurcation (aSB) algorithm, a ballistic simulated bifurcation (bSB) algorithm, and a discrete simulated bifurcation (dSB) algorithm.

In a case where the processing according to the adiabatic simulated bifurcation algorithm is executed, the simulated bifurcation machine executes an operation represented by Expression (16-1) in the y update processing (S114) and executes an operation represented by Expression (16-2) in the x update processing (S115). Note that, in a case where the processing according to the adiabatic simulated bifurcation algorithm is executed, the simulated bifurcation machine does not execute the wall process (S115).

$$( 16 - 1 )$$

$${y}_{i} ( {t}_{k + 1} ) = {y}_{i} ( {t}_{k} ) + \{ - {Kx}_{i}^{3} ( {t}_{k} ) - [ {a}_{0} - a ( {t}_{k} ) ] {x}_{j} ( {t}_{k} ) - η {h}_{i} + {c}_{0} {\sum }_{j = 1}^{N} {J}_{i , j} {x}_{j} ( {t}_{k} ) \} {Δ}_{t}$$

$${x}_{i} ( {t}_{k + 1} ) = {x}_{i} ( {t}_{k} ) + {a}_{0} {y}_{i} ( {t}_{k + 1} ) {Δ}_{t} \qquad ( 16 - 2 )$$

In a case where the processing according to the ballistic simulated bifurcation algorithm is executed, the simulated bifurcation machine executes an operation represented by Expression (17-1) in the y update processing (S114), executes an operation represented by Expression (17-2) in the x update processing (S115), and executes an operation represented by Expression (17-3) in the wall processing (S116).

$$( 17 - 1 )$$

$${y}_{i} ( {t}_{k + 1} ) = {y}_{i} ( {t}_{k} ) + \{ - [ {a}_{0} - a ( {t}_{k} ) ] {x}_{i} ( {t}_{k} ) - η {h}_{i} + {c}_{0} {\sum }_{j = 1}^{N} {J}_{i , j} {x}_{j} ( {t}_{k} ) \} {Δ}_{t}$$

$${x}_{i} ( {t}_{k + 1} ) = {x}_{i} ( {t}_{k} ) + {a}_{0} {y}_{i} ( {t}_{k + 1} ) {Δ}_{t} \qquad ( 17 - 2 )$$

$$if \vert {x}_{i} ( {t}_{k + 1} ) \vert > 1 , set {x}_{j} ( {t}_{k + 1} ) = sgn ( {x}_{i} ( {t}_{k + i} ) ) and {y}_{i} ( {t}_{k + 1} ) = 0 \qquad ( 17 - 3 )$$

In a case where the processing according to the discrete simulated bifurcation algorithm is executed, the simulated bifurcation machine executes an operation represented by Expression (18-1) in the y update processing (S114), executes an operation represented by Expression (18-2) in the x update processing (S115), and executes an operation represented by Expression (18-3) in the wall processing (S116).

$$( 18 - 1 )$$

$${y}_{i} ( {t}_{k + 1} ) = {y}_{i} ( {t}_{k} ) + \{ - [ {a}_{0} - a ( {t}_{k} ) ] {x}_{i} ( {t}_{k} ) - η {h}_{i} + {c}_{0} {\sum }_{j = 1}^{N} {J}_{i , j} sgn [ {x}_{i} ( {t}_{k} ) ] \} {Δ}_{t}$$

$${x}_{i} ( {t}_{k + 1} ) = {x}_{i} ( {t}_{k} ) + {a}_{0} {y}_{i} ( {t}_{k + 1} ) {Δ}_{t} \qquad ( 18 - 2 )$$

$$if \vert {x}_{i} ( {t}_{k + 1} ) \vert > 1 , set {x}_{i} ( {t}_{k + 1} ) = sgn ( {x}_{i} ( {t}_{k + i} ) ) and {y}_{i} ( {t}_{k + 1} ) = 0 \qquad ( 18 - 3 )$$

In Expressions (16-1), (16-2), (17-1), (17-2), (17-3), (18-1), (18-2), and (18-3), each of tₖ and tₖ₊₁ represent a time. tₖ₊₁ is a time obtained by adding a unit time (Δt) to tₖ.

xᵢ (tₖ) indicates a value of the i-th position variable (xᵢ) at the time (tₖ). xᵢ (tₖ₊₁) indicates a value of the i-th position variable (xᵢ) at the time (tₖ₊₁). yᵢ (tₖ) indicates a value of the i-th momentum variable (yᵢ) at the time (tₖ). yᵢ (tₖ₊₁) indicates a value of the i-th momentum variable (yᵢ) at the time (tₖ₊₁).

K, a₀, η, and c₀ are predetermined constants. a(tₖ) is a function that changes according to a time. a(tₖ), where, for example, a(t₁)=0, is a positive real number that increases as the time increases, and is a function that is a₀ at the end time (T) (a (T)=a₀). Moreover, sgn(xᵢ(tₖ)) is a function that outputs the sign of the i-th position variable (xᵢ) at the time (tₖ), and is +1 when xᵢ (tₖ) is greater than or equal to zero and −1 when xᵢ (tₖ) is less than zero.

In a case where the process of S114 to S116 are executed a predetermined number of times, that is, in a case where the operation is executed until time t reaches final time T, the simulated bifurcation machine exits the loop processing between S113 and S117 and advances the process to S118.

In S118, the simulated bifurcation machine outputs N position variables (x₁ to x_{N}) at the final time or N decision variables (S11 to s_{N}) calculated based on the N position variables (x₁ to x_{N}) at the final time. The simulated bifurcation machine calculates the i-th decision variable (sᵢ) among the N decision variables (S11 to s_{N}) based on sgn (x₁).

When the process of S118 ends, the simulated bifurcation machine ends the process according to the simulated bifurcation algorithm.

Note that the number of repetitions of the time evolution processing (loop processing between S113 and S117) is determined in advance in accordance with the application. The calculation amount necessary for one process (one process of S114 to S116) in the time evolution process does not change. Therefore, the simulated bifurcation machine can reduce the fluctuation in the solving time. Therefore, even when the simulated bifurcation machine is applied to a real-time system having a time constraint that the processing is required to be completed by a predetermined time, the solution can be reliably output by the predetermined time.

Furthermore, for example, as disclosed in JP 2021-060864 A, the simulated bifurcation machine can be configured using a dedicated parallel processing circuit including a large number of arithmetic units. As a result, the simulated bifurcation machine can extremely shorten the calculation time of one process in the time evolution process. In addition, unlike the case of software processing, in a simulated bifurcation machine mounted on a dedicated hardware circuit, any interrupt processing does not occur, so that the solving time is strictly fixed. For example, a simulated bifurcation machine mounted on a dedicated hardware circuit can fix the time until a solution is obtained in units of clock cycles. Therefore, in a case where the simulated bifurcation machine mounted on a dedicated hardware circuit is applied to a real-time system, it is possible to output a solution while more reliably protecting a time constraint.

### Hardware Configuration

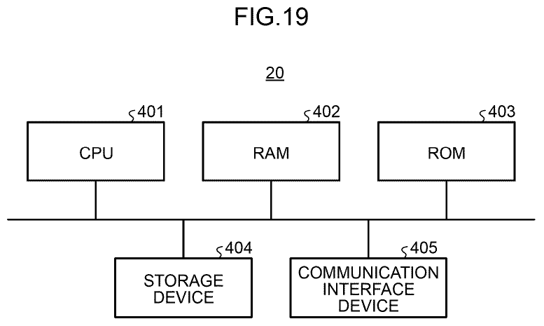

FIG. 19 is a diagram illustrating an example of a hardware configuration of a computer. The self-position estimation device 20 is implemented by a computer having a hardware configuration as illustrated in FIG. 19, for example. The self-position estimation device 20 includes a CPU 401, a RAM 402, a ROM 403, a storage device 404, and a communication interface device 405. These units are connected by a bus.

The CPU 401 is one or more processors that executes an arithmetic process, a control process, and the like according to a program. The CPU 401 uses a predetermined region of the RAM 402 for a work region, and executes various processes in cooperation with programs stored in the ROM 403, the storage device 404, and so forth.

The RAM 402 is a memory such as a synchronous dynamic random access memory (SDRAM). The RAM 402 functions as a work region of the CPU 401. The ROM 403 is a memory that stores programs and various types of information in a non-rewritable manner.

The storage device 404 is a device that writes and reads data to and from a semiconductor storage medium such as a flash memory, a magnetically or optically recordable storage medium, or the like. The storage device 404 writes and reads data to and from the storage medium under the control of the CPU 401. The communication interface device 405 communicates with an external device via a network in accordance with control from the CPU 401.

The program executed by the computer causes the computer to function as the self-position estimation device 20. This program is developed on the RAM 402 and executed by the CPU 401 (processor).

In addition, the program executed by the computer is recorded in and provided by a computer-readable recording medium such as a CD-ROM, a flexible disk, a CD-R, or a digital versatile disk (DVD) as a file in a format that can be installed or executed in the computer.

Moreover, the program may be stored on a computer connected to a network such as the Internet and provided by being downloaded via the network. Moreover, the program may be provided or distributed via a network such as the Internet. In addition, the program executed by the self-position estimation device 20 may be provided by being incorporated in the ROM 403 or the like in advance.

The program for causing the computer to function as the self-position estimation device 20 includes, for example, an image processing module, a feature point detection module, a feature amount calculation module, a matching module, and an estimation module. This program is executed by the CPU 401 to load each module into the RAM 402, and causes the CPU 401 to function as a processing unit including the image processing unit 32, the feature point detection unit 34, the feature amount calculation unit 36, the matching unit 40, and the estimation unit 42. In a case where the CPU 401 is a plurality of processors, these units may be divided into and carried by a plurality of processors. Note that some or all of these configurations may be configured by hardware. In addition, this program causes the RAM 402 or the storage device 404 to function as the past information storage unit 38.

Moreover, the processing unit of the self-position estimation device 20 may be implemented by one or more reconfigurable semiconductor devices such as a field-programmable gate array (FPGA). Moreover, the self-position estimation device 20 may be implemented by an electronic circuit including one or more hardware processors, one or more CPUs, a microprocessor, a GPU, an application specific integrated circuit (ASIC), or circuits thereof.

Moreover, in a case where the processing unit of the self-position estimation device 20 is implemented by a reconfigurable semiconductor device such as an FPGA, circuit information (configuration data) written in the reconfigurable semiconductor device to operate the reconfigurable semiconductor device as the processing unit of the self-position estimation device 20 may be stored on a computer connected to a network such as the Internet and provided by being downloaded via the network. In addition, circuit information (configuration data) written in the reconfigurable semiconductor device in order to operate the reconfigurable semiconductor device as the processing unit of the self-position estimation device 20 may be recorded in a computer-readable recording medium and provided.

Furthermore, in a case where the processing unit of the self-position estimation device 20 is realized by a semiconductor device such as an ASIC, circuit information representing a configuration of a circuit described in a hardware description language used for designing and manufacturing the processing unit of the self-position estimation device 20 may be stored on a computer connected to a network such as the Internet, and may be provided by being downloaded via a network. Furthermore, circuit information representing a configuration of a circuit described in a hardware description language used for designing and manufacturing the self-position estimation device 20 may be provided by being recorded in a computer-readable recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### SUPPLEMENTARY NOTE

Note that the present technique can also have the following configurations.

### Supplementary Note 1

An information processing device comprising
a processing unit configured to:
   generate, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and
   generate, based on a solution to the matching problem, a corresponding point list representing a corresponding point pair including any first feature point of the N first feature points and an associated second feature point among the M second feature points.

### Supplementary Note 2

The information processing device according to Supplementary Note 1, wherein
the processing unit is configured to:
provide the matching problem to a solver device that solves the combination optimization problem to cause the solver device to solve the matching problem; and
acquire a solution to the matching problem from the solver device.

### Supplementary Note 3

The information processing device according to Supplementary Note 2, wherein
the matching problem is a combination optimization problem that maximizes or minimizes an objective function,
the objective function includes (N×M) decision variables, and is minimized or maximized in a case where all the (N×M) decision variables are set to correct answer values,
in a case where the (N×M) decision variables are disposed in N rows and M columns, a value of a decision variable of an i-th row×a j-th column among the (N×M) decision variables indicates whether an i-th first feature point among the N first feature points and a j-th second feature point among the M second feature points are the corresponding point pair, where i is an integer greater than or equal to one and less than or equal to N, and j is an integer greater than or equal to one and less than or equal to M, and
the correct answer value of the decision variable of the i-th row×the j-th column is a value indicating that the i-th first feature point and the j-th second feature point are the corresponding point pair in a case where the i-th first feature point and the j-th second feature point correspond to the same object, and is a value indicating that the i-th first feature point and the j-th second feature point are not the corresponding point pair in a case where the i-th first feature point and the j-th second feature point does not correspond to the same object.

### Supplementary Note 4

The information processing device according to Supplementary Note 3, wherein
the objective function includes a term in which the decision variable of the i-th row×the j-th column, a decision variable in an i′-th row×a j′-th column among the (N×M) decision variables, and a co-occurrence score are multiplied, where i′ is an integer greater than or equal to one and less than or equal to N and j′ is an integer greater than or equal to one and less than or equal to N, and
the co-occurrence score included in the term in which the decision variable of the i-th row×the j-th column and the decision variable of the i′-th row×the j′-th column are multiplied is a value representing validity of simultaneous existence of the corresponding point pair of the i-th first feature point and the j-th second feature point and the corresponding point pair of an i′-th first feature point among the N first feature points and a j′-th second feature point among the M second feature points.

### Supplementary Note 5

The information processing device according to Supplementary Note 4, wherein
the co-occurrence score included in the term in which the decision variable of the i-th row×the j-th column and the decision variable of the i′-th row×the j′-th column are multiplied
is a value depending on a degree of approximation between a first positional relationship between an image position of the i-th first feature point and an image position of the j-th second feature point and a second positional relationship between an image position of the i′-th first feature point and an image position of the j′-th second feature point.

### Supplementary Note 6

The information processing device according to Supplementary Note 4, wherein
the co-occurrence score included in the term in which the decision variable of the i-th row×the j-th column and the decision variable of the i′-th row×the j′-th column are multiplied
is a value obtained by combining:
a first degree of approximation between a first positional relationship between an image position of the i-th first feature point and an image position of the j-th second feature point and a second positional relationship between an image position of the i′-th first feature point and an image position of the j′-th second feature point; and
a second degree of approximation between a third positional relationship between an estimated image position of the j-th second feature point at a time of the first image and an image position of the j-th second feature point and a fourth positional relationship between an image position of the i′-th first feature point and an image position of the j′-th second feature point.

### Supplementary Note 7

The information processing device according to any one of Supplementary Notes 4 to 6, wherein
in a case where a first condition that a distance between a position of the i-th first feature point and a position of the i′-th first feature point are less than or equal to a predetermined distance is satisfied,
the co-occurrence score included in the term in which the decision variable of the i-th row×the j-th column and the decision variable of the i′-th row×the j′-th column are multiplied
is a value depending on a difference in amount of movement between a first amount of movement of an object represented by the corresponding point pair of the i-th first feature point and the j-th second feature point and a second amount of movement of an object represented by the corresponding point pair of the i′-th first feature point and the j′-th second feature point.

### Supplementary Note 8

The information processing device according to any one of Supplementary Notes 4 to 7, wherein
in a case where a second condition that the first image and the second image are images captured by a camera moved parallel to an optical axis is satisfied,
the co-occurrence score included in the term in which the decision variable of the i-th row×the j-th column and the decision variable of the i′-th row×the j′-th column are multiplied
is a value depending on a correlation between a size and an amount of movement from a vanishing point on an image of a first object represented by the corresponding point pair of the i-th first feature point and the j-th second feature point, and a size and an amount of movement from a vanishing point on an image of a second object represented by the corresponding point pair of the i′-th first feature point and the j′-th second feature point.

### Supplementary Note 9

The information processing device according to any one of Supplementary Notes 4 to 7, wherein
in a case where a third condition that the first image and the second image are images captured by a camera having an optical axis turned is satisfied,
the co-occurrence score included in the term in which the decision variable of the i-th row×the j-th column and the decision variable of the i′-th row×the j′-th column are multiplied is a value depending on a difference in movement between a movement direction and an amount of movement of an object represented by the corresponding point pair of the i-th first feature point and the j-th second feature point and a movement direction and an amount of movement of an object represented by the corresponding point pair of the i′-th first feature point and the j′-th second feature point.

### Supplementary Note 10

The information processing device according to any one of Supplementary Notes 3 to 9, wherein
the objective function includes a term in which the decision variable of the i-th row×the j-th column and a feature amount score are multiplied, and
the feature amount score by which the decision variable of the i-th row×the j-th column is multiplied
is a value depending on similarity between a feature amount of the i-th first feature point and a feature amount of the j-th second feature point.

### Supplementary Note 11

The information processing device according to any one of Supplementary Notes 3 to 10, wherein
the objective function includes a term in which the decision variable of the i-th row×the j-th column and a position score are multiplied, and
the position score by which the decision variable of the i-th row×the j-th column is multiplied
is a value depending on an estimated distance between an estimated position of the j-th second feature point at a time of the first image and a position of the i-th first feature point.

### Supplementary Note 12

The information processing device according to any one of Supplementary Notes 1 to 11, wherein
the processing unit is configured to select G candidate points among the M second feature points for each of the N first feature points, where G is an integer greater than or equal to one and less than M,
the matching problem is a combination optimization problem that maximizes or minimizes an objective function,
the objective function includes (N×G) decision variables, and is minimized or maximized in a case where all the (N×G) decision variables are set to correct answer values,
in a case where the (N×G) decision variables are disposed in N rows and G columns, a value of a decision variable of an i-th row×a j-th column among the (N×G) decision variables indicates whether an i-th first feature point among the N first feature points and a j-th candidate point among the G candidate points selected for the i-th first feature point are the corresponding point pair, where i is an integer greater than or equal to one and less than or equal to N and j is an integer greater than or equal to one and less than or equal to G, and
the correct answer value of the decision variable of the i-th row×the j-th column is a value indicating that the i-th first feature point and the j-th candidate point selected for the i-th first feature point are the corresponding point pair in a case where the i-th first feature point and the j-th candidate point selected for the i-th first feature point correspond to the same object, and is a value indicating that the i-th first feature point and the j-th candidate point selected for the i-th first feature point are not the corresponding point pair in a case where the i-th first feature point and the j-th candidate point selected for the i-th first feature point does not correspond to the same object.

### Supplementary Note 13

The information processing device according to any one of Supplementary Notes 1 to 12, wherein
the first image is a first partial image among a plurality of partial images obtained by dividing a first input image in association with a plurality of predetermined regions, and
the second image is a second partial image in the same region as the first partial image among a plurality of partial images obtained by dividing a second input image different from the first input image.

### Supplementary Note 14

The information processing device according to Supplementary Note 13, wherein
a first region and a second region adjacent to each other among the plurality of predetermined regions partially overlap each other, and
the processing unit is configured to:
   generate a composite corresponding point list obtained by combining the corresponding point lists each generated using, as the first image, one of the plurality of partial images obtained by dividing the first input image; and
   delete a part of the two or more corresponding point pairs in which at least one of the first feature point and the second feature point overlaps, such that the composite corresponding point list does not include the two or more corresponding point pairs in which at least one of the first feature point and the second feature point overlaps.

### Supplementary Note 15

The information processing device according to Supplementary Note 13, wherein
a first region and a second region adjacent to each other among the plurality of predetermined regions partially overlap each other, and
the processing unit is configured to:
   generate a composite corresponding point list obtained by combining the corresponding point lists each generated using, as the first image, one of the plurality of partial images obtained by dividing the first input image;
   in a case where the composite corresponding point list includes two or more corresponding point pairs in which at least one of the first feature point and the second feature point overlaps, identify a new partial region including the two or more corresponding point pairs;
   generate the matching problem again based on a plurality of first feature points detected from the new partial region in the first input image and a plurality of second feature points detected from the new partial region in the second input image;
   generate one or more new corresponding point pairs in which any first feature point of the plurality of first feature points is associated with any second feature point of the plurality of second feature points, based on a solution to the matching problem generated again; and
   replace the two or more corresponding point pairs in which at least one of the first feature point and the second feature point overlaps, with the new one or more corresponding point pairs, and update the composite corresponding point list.

### Supplementary Note 16

The information processing device according to any one of Supplementary Notes 1 to 14, wherein
the processing unit is configured to:
   extract the N first feature points from the first image captured by a camera and the M second feature points from a second image captured by the camera at a time different than the first image; and
   estimate a position of the camera in a three-dimensional space based on the corresponding point list.

### Supplementary Note 17

An information processing method executed by an information processing device, the information processing method comprising:
generating, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and
generating, based on a solution to the matching problem, a corresponding point list representing a corresponding point pair including any first feature point of the N first feature points and an associated second feature point among the M second feature points.

### Supplementary Note 18

A program for causing a computer to execute information processing,
the program causing the computer to:
   generate, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and
   generate, based on a solution to the matching problem, a corresponding point list representing a corresponding point pair including any first feature point of the N first feature points and an associated second feature point among the M second feature points.

### Supplementary Note 19

Circuit information described in a hardware description language and representing a configuration of a circuit, the circuit information causing the circuit to function as an information processing device,
the information processing device being configured to
   generate, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and
   generate, based on a solution to the matching problem, a corresponding point list representing a corresponding point pair including any first feature point of the N first feature points and an associated second feature point among the M second feature points.

### Supplementary Note 20

Circuit information to be written into a reconfigurable semiconductor device to operate the reconfigurable semiconductor device,
the circuit information causing the reconfigurable semiconductor device to function as an information processing device,
the information processing device being configured to
   generate, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and
   generate, based on a solution to the matching problem, a corresponding point list representing a corresponding point pair including any first feature point of the N first feature points and an associated second feature point among the M second feature points.

What is claimed is:

1. An information processing device comprising
one or more hardware processors configured to:
generate, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and
generate, based on a solution to the matching problem, a corresponding point list representing a corresponding point pair including any first feature point of the N first feature points and an associated second feature point among the M second feature points.

2. The information processing device according to claim 1, wherein
the one or more hardware processors is configured to:
provide the matching problem to a solver device that solves the combination optimization problem to cause the solver device to solve the matching problem; and
acquire a solution to the matching problem from the solver device.

3. The information processing device according to claim 2, wherein
the matching problem is a combination optimization problem that maximizes or minimizes an objective function,
the objective function includes (N×M) decision variables, and is minimized or maximized in a case where all the (N×M) decision variables are set to correct answer values,
in a case where the (N×M) decision variables are disposed in N rows and M columns, a value of a decision variable of an i-th row×a j-th column among the (N×M) decision variables indicates whether an i-th first feature point among the N first feature points and a j-th second feature point among the M second feature points are the corresponding point pair, where i is an integer greater than or equal to one and less than or equal to N, and j is an integer greater than or equal to one and less than or equal to M, and
the correct answer value of the decision variable of the i-th row×the j-th column is a value indicating that the i-th first feature point and the j-th second feature point are the corresponding point pair in a case where the i-th first feature point and the j-th second feature point correspond to the same object, and is a value indicating that the i-th first feature point and the j-th second feature point are not the corresponding point pair in a case where the i-th first feature point and the j-th second feature point does not correspond to the same object.

4. The information processing device according to claim 3, wherein
the objective function includes a term in which the decision variable of the i-th row×the j-th column, a decision variable in an i′-th row×a j′-th column among the (N×M) decision variables, and a co-occurrence score are multiplied, where i′ is an integer greater than or equal to one and less than or equal to N and j′ is an integer greater than or equal to one and less than or equal to N, and
the co-occurrence score included in the term in which the decision variable of the i-th row×the j-th column and the decision variable of the i′-th row×the j′-th column are multiplied is a value representing validity of simultaneous existence of the corresponding point pair of the i-th first feature point and the j-th second feature point and the corresponding point pair of an i′-th first feature point among the N first feature points and a j′-th second feature point among the M second feature points.

5. The information processing device according to claim 4, wherein
the co-occurrence score included in the term in which the decision variable of the i-th row×the j-th column and the decision variable of the i′-th row×the j′-th column are multiplied
is a value depending on a degree of approximation between a first positional relationship between an image position of the i-th first feature point and an image position of the j-th second feature point and a second positional relationship between an image position of the i′-th first feature point and an image position of the j′-th second feature point.

6. The information processing device according to claim 4, wherein
the co-occurrence score included in the term in which the decision variable of the i-th row×the j-th column and the decision variable of the i′-th row×the j′-th column are multiplied
is a value obtained by combining:
a first degree of approximation between a first positional relationship between an image position of the i-th first feature point and an image position of the j-th second feature point and a second positional relationship between an image position of the i′-th first feature point and an image position of the j′-th second feature point; and
a second degree of approximation between a third positional relationship between an estimated image position of the j-th second feature point at a time of the first image and an image position of the j-th second feature point and a fourth positional relationship between an image position of the i′-th first feature point and an image position of the j′-th second feature point.

7. The information processing device according to claim 4, wherein
in a case where a first condition that a distance between a position of the i-th first feature point and a position of the i′-th first feature point are less than or equal to a predetermined distance is satisfied,
the co-occurrence score included in the term in which the decision variable of the i-th row×the j-th column and the decision variable of the i′-th row×the j′-th column are multiplied
is a value depending on a difference in amount of movement between a first amount of movement of an object represented by the corresponding point pair of the i-th first feature point and the j-th second feature point and a second amount of movement of an object represented by the corresponding point pair of the i′-th first feature point and the j′-th second feature point.

8. The information processing device according to claim 4, wherein
in a case where a second condition that the first image and the second image are images captured by a camera moved parallel to an optical axis is satisfied,
the co-occurrence score included in the term in which the decision variable of the i-th row×the j-th column and the decision variable of the i′-th row×the j′-th column are multiplied
is a value depending on a correlation between a size and an amount of movement from a vanishing point on an image of a first object represented by the corresponding point pair of the i-th first feature point and the j-th second feature point, and a size and an amount of movement from a vanishing point on an image of a second object represented by the corresponding point pair of the i′-th first feature point and the j′-th second feature point.

9. The information processing device according to claim 4, wherein
in a case where a third condition that the first image and the second image are images captured by a camera having an optical axis turned is satisfied,
the co-occurrence score included in the term in which the decision variable of the i-th row×the j-th column and the decision variable of the i′-th row×the j′-th column are multiplied is a value depending on a difference in movement between a movement direction and an amount of movement of an object represented by the corresponding point pair of the i-th first feature point and the j-th second feature point and a movement direction and an amount of movement of an object represented by the corresponding point pair of the i′-th first feature point and the j′-th second feature point.

10. The information processing device according to claim 3, wherein
the objective function includes a term in which the decision variable of the i-th row×the j-th column and a feature amount score are multiplied, and
the feature amount score by which the decision variable of the i-th row×the j-th column is multiplied
is a value depending on similarity between a feature amount of the i-th first feature point and a feature amount of the j-th second feature point.

11. The information processing device according to claim 3, wherein
the objective function includes a term in which the decision variable of the i-th row×the j-th column and a position score are multiplied, and
the position score by which the decision variable of the i-th row×the j-th column is multiplied
is a value depending on an estimated distance between an estimated position of the j-th second feature point at a time of the first image and a position of the i-th first feature point.

12. The information processing device according to claim 1, wherein
the one or more hardware processors is configured to select G candidate points among the M second feature points for each of the N first feature points, where G is an integer greater than or equal to one and less than M,
the matching problem is a combination optimization problem that maximizes or minimizes an objective function,
the objective function includes (N×G) decision variables, and is minimized or maximized in a case where all the (N×G) decision variables are set to correct answer values,
in a case where the (N×G) decision variables are disposed in N rows and G columns, a value of a decision variable of an i-th row×a j-th column among the (N×G) decision variables indicates whether an i-th first feature point among the N first feature points and a j-th candidate point among the G candidate points selected for the i-th first feature point are the corresponding point pair, where i is an integer greater than or equal to one and less than or equal to N and j is an integer greater than or equal to one and less than or equal to G, and
the correct answer value of the decision variable of the i-th row×the j-th column is a value indicating that the i-th first feature point and the j-th candidate point selected for the i-th first feature point are the corresponding point pair in a case where the i-th first feature point and the j-th candidate point selected for the i-th first feature point correspond to the same object, and is a value indicating that the i-th first feature point and the j-th candidate point selected for the i-th first feature point are not the corresponding point pair in a case where the i-th first feature point and the j-th candidate point selected for the i-th first feature point does not correspond to the same object.

13. The information processing device according to claim 1, wherein
the first image is a first partial image among a plurality of partial images obtained by dividing a first input image in association with a plurality of predetermined regions, and
the second image is a second partial image in the same region as the first partial image among a plurality of partial images obtained by dividing a second input image different from the first input image.

14. The information processing device according to claim 13, wherein
a first region and a second region adjacent to each other among the plurality of predetermined regions partially overlap each other, and
the one or more hardware processors is configured to:
generate a composite corresponding point list obtained by combining the corresponding point lists each generated using, as the first image, one of the plurality of partial images obtained by dividing the first input image; and
delete a part of the two or more corresponding point pairs in which at least one of the first feature point and the second feature point overlaps, such that the composite corresponding point list does not include the two or more corresponding point pairs in which at least one of the first feature point and the second feature point overlaps.

15. The information processing device according to claim 13, wherein
a first region and a second region adjacent to each other among the plurality of predetermined regions partially overlap each other, and
the one or more hardware processors is configured to:
generate a composite corresponding point list obtained by combining the corresponding point lists each generated using, as the first image, one of the plurality of partial images obtained by dividing the first input image;
in a case where the composite corresponding point list includes two or more corresponding point pairs in which at least one of the first feature point and the second feature point overlaps, identify a new partial region including the two or more corresponding point pairs;
generate the matching problem again based on a plurality of first feature points detected from the new partial region in the first input image and a plurality of second feature points detected from the new partial region in the second input image;
generate one or more new corresponding point pairs in which any first feature point of the plurality of first feature points is associated with any second feature point of the plurality of second feature points, based on a solution to the matching problem generated again; and
replace the two or more corresponding point pairs in which at least one of the first feature point and the second feature point overlaps, with the new one or more corresponding point pairs, and update the composite corresponding point list.

16. The information processing device according to claim 1, wherein
the one or more hardware processors is configured to:
extract the N first feature points from the first image captured by a camera and the M second feature points from a second image captured by the camera at a time different than the first image; and
estimate a position of the camera in a three-dimensional space based on the corresponding point list.

17. An information processing method executed by an information processing device, the information processing method comprising:
generating, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and
generating, based on a solution to the matching problem, a corresponding point list representing a corresponding point pair including any first feature point of the N first feature points and an associated second feature point among the M second feature points.

18. A computer program product comprising a non-transitory computer-readable medium including program information, the program information comprising at least one of:
(i) instructions for execution by a processor;
(ii) circuit information described in a hardware description language representing a configuration of a circuit; and
(iii) circuit information to be written into a reconfigurable semiconductor device to operate the reconfigurable semiconductor device,
wherein the program information causing a computer or a circuit to:
generate, based on N first feature points detected from a first image and M second feature points detected from a second image different from the first image, a matching problem that is a combination optimization problem of associating, with each of the N first feature points, any second feature point estimated to represent the same object among the M second feature points, where N and M are integers greater than or equal to one; and
generate, based on a solution to the matching problem, a corresponding point list representing a corresponding point pair including any first feature point of the N first feature points and an associated second feature point among the M second feature points.

19. The computer program product of claim 18, wherein the program information comprises programmed instructions for execution by a processor.

20. The computer program product of claim 18, wherein the program information comprises circuit information described in a hardware description language.

21. A server comprising:
the computer program product according to claim 20.

22. The computer program product of claim 18, wherein the program information comprises circuit information to be written into a reconfigurable semiconductor device.

23. A server comprising:
the computer program product according to claim 22.
